(19) United States
(12) Patent Application Publication
(10) Pub. No.: US 2001/0051274 A1
(43) Pub. Date: Dec. 13, 2001

(54) Antifouling compounds and uses thereof

(76) Inventors: Randall S. Alberte, Falmouth, ME (US); Richard C. Zimmerman, Pacific Grove, CA (US)

Correspondence Address: FOLEY, HOAG & ELIOT, LLP, PATENT GROUP, ONE POST OFFICE SQUARE, BOSTON, MA, 02109, US

(21) Appl. No.: 09/778,012

(22) Filed: Feb. 6, 2001

Related U.S. Application Data
(62) Division of application No. 09/406,184, filed on Sep. 23, 1999.
Application No. 09/406,184 is a continuation-in-part of application No. 09/159,814, filed on Sep. 23, 1998.

(51) Int. Cl. B32B 9/04

(52) U.S. Cl. 428/411.1; 523/122; 424/411

(57) ABSTRACT

Disclosed are improved compounds for preventing biofilm formation and preventing biofouling of surfaces. By interfering with the attachment of the organisms to surfaces, the instant claimed compounds have broad inhibitory activity. In addition, the compounds are biodegradable into environmentally safe compounds.

### BACKGROUND OF THE INVENTION

Fouling due to the growth of biologics on surfaces submerged in liquids or exposed to aqueous vapors can lead to deterioration of the surface, compromised functional aspects of the material, and a reduction in the overall desired function of the structure. A broad range of organisms can contribute to fouling. The commonly observed fouling of boat bulls arises from a variety of fouling organisms, ranging from bacteria and algae to invertebrates. The less conspicuous pitting and failure of metal alloy welds occurs due to fouling by bacteria that drive corrosion.

Fouling events involve recognition between an organism and a surface, adhesion of the organism to the surface, and the subsequent growth and biological activity of the organism. Recognition of a surface is a necessary primary event that is followed by adhesion to the surface. Fouling commonly involves non-specific recognition of a surface by a fouling organism.

The activity of the attached organism can result in secondary impacts, including the production and release of metabolites, e.g. toxins, enzymes, or small molecules that deteriorate tissues or materials; and the growth and multiplication of the fouling organism, which magnifies the overall fouling event.

The control of fouling has been a significant target of research and development. Aquatic antifouling coatings and paints are used to prevent the attachment of organisms to underwater surfaces such as ships, boats, harbor infrastructures, piping and cables. The cost of cleaning fouled surfaces is expensive for naval and commercial fleets, leisure boat owners, harbors and operators of off-shore platforms. The U.S. Navy has calculated that even a slight biomass build-up on hulls of larger vessels reduces fuel economy by 15%.

Currently available chemical agents that control or inhibit fouling, termed antifouling (AF) agents, can be categorized into three general classes: 1) Agents that kill fouling organisms; 2) Agents that dissolve or solubilize the extracellular polymers involved in adhesion; and 3) Agents that mask the ability of fouling organisms to attach to surfaces (Clare et al., (1996) Biofouling 9: 211-229).

AF agents that kill fouling organisms, are typically called biocides. Biocides include such compounds as organic complexes of heavy metals (e.g. tin, zinc, copper, metal oxides) and also a diversity of organic compounds such as Sea Nine-211™ (a thiazolone commercial product by Rohm-Haas), IRGANOL 1051™ (a triazine), phenol, antibiotics, and 70% alcohol. Heavy metal biocides kill organisms primarily through their substitution for metals such as cobalt, iron, and molydium, that function in redox centers of enzymes, or act as cofactors in critical bio-processes. Other biocides function as chaeotropic agents, which disrupt cell membrane functions of biofouling organisms leading to cell death. Examples of these biocides include earth metal salts (e.g., lithium), certain organics, and detergents. Yet other biocides interfere with critical cellular processes such as cell division, cytoskeletal arrangement, enzyme function, or nucleic acid related processes (e.g. DNA replication, transcription, and translation). The mode-of-action of many biocides are unknown.

Though biocides, like organotin and certain organics, are highly effective at controlling fouling through the killing of fouling organisms, their non-specificity results in the killing of non-target organisms as well. In some cases, the biocidal agents have very long environmental lifetimes, remaining active in the environment for extended periods, generating significant negative environmental impacts. For these reasons, the use of many biocides has been either banned from use, or highly regulated in many areas of the world. For example, use of organo-tin coatings are already banned in Europe and legislation in the U.S. is moving to a ban of these products as well.

The second class of AF agents, listed above, functions primarily to reduce adhesion of fouling organisms by dissolving or solubilizing the extracellular polymers involved in adhesion to a surface. This class of AF agents includes detergents and lipophilic organics and is used primarily to release or remove fouling organisms that have already adhered to surfaces. These AF agents are effective in certain situations, such as the removal of bacterial films, but have proven much less effective for fouling by larger organisms like, algae and invertebrates.

The third and the least well-developed class of AF agents are those that interfere with the initial adhesion or attachment to surfaces. This class of AF agents includes compounds that are essentially non-toxic. That is to say, their AF mode-of-action is to interfere with processes involved in fouling, without killing the organisms. Lectins are one example of this class of AF agent. Lectins are produced by several plant species, and function by binding to extracellular polymers containing specific sugar residues. Unfortunately, the cost of these compounds prohibits the wide spread commercialization of lectins as AF agents. Another commercial drawback is that many lectins are highly toxic to humans.

Until recently, progress on the development of non-toxic modes of fouling control has been hampered by low economic impetus, since inexpensive toxic agents have provided extended protection from fouling. However, enhanced regulatory controls regarding environmental impacts resulting from the use of AF agents has driven a recent resurgence of interest in non-toxic fouling control. Currently, a significant need exists for non-toxic, environmentally benign and biologically safe fouling control agents.

One such promising AF agent, zosteric acid, has been previously described (Zimmerman et al., (1995) U.S. Pat. No. 5,384,176; Zimmerman et al., (1997) U.S. Pat. No. 5,607,741). Zosteric acid is a phenolic acid sulfate ester, produced naturally by the seagrass Zostera marina. The presence of zosteric acid in a marine environment, effectively inhibits fouling of surfaces by a wide variety of marine organisms by interfering with their ability to attach. A series of investigations performed on several species of bacteria, microalgae, macroalgal spores and invertebrates has confirmed that zosteric acid's mode-of-action is through a non-toxic means (Zimmerman et al., (1995) U.S. Pat. No. 5,384,176; Zimmerman et al., (1997) U.S. Pat. No. 5,607,741; Todd et al., Phytochemistry 34: 401-404 (1993); Sundberg et al., Naval Research Reviews (1997) 4:51-59). These references also suggest that the following related compounds would have the same activity as zosteric acid. P-sulfoxy cinnamic acid, p-sulfoxyferulic acid, m,p-disulfoxy caffeic acid, benzoic acid sulfate, vanillic acid sulfate, gentissic acid sulfate, gallic acid sulfate and protochateuic acid.

### SUMMARY OF THE INVENTION

In one aspect, the instant invention features improved antifouling compounds having the general structure 1:

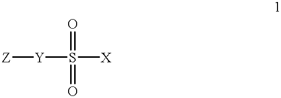

wherein

X represents —OH, —O(aryl), —O(acyl), —O(sulfonyl), —CN, F, Cl, or Br;

Y represents O, S, Se, or NR;

Z represents optionally substituted alkyl, heteroalkyl, cycloalkyl, heterocycloalkyl, aryl, heteroaryl, aralkyl, heteroaralkyl, or —(CH₂)ₘ—R₈₀;

R represents independently for each occurrence hydrogen, alkyl, heteroalkyl, aryl, heteroaryl, aralkyl, heteroaralkyl, or —(CH₂)ₘ—R₈₀;

R₈₀ represents independently for each occurrence aryl, cycloalkyl, cycloalkenyl, heterocyclyl, or polycyclyl; and

m is an integer in the range 0 to 8 inclusive. Other preferred antifouling compounds are salts of the compounds of structure 1.

By interfering with the attachment of organisms to surfaces, the instant claimed antifouling agents have broad applicability in effectively inhibiting a variety of organisms. In addition, the compounds are environmentally benign, as they naturally degrade into carbon dioxide and water, or simple organic acids.

In addition, certain preferred compounds exhibit increased stability and compatibility with chemicals used in standard coatings. Other preferred compounds result in a constant, sustained release. Still other compounds have a relatively short half-life after release rendering them particularly safe for widespread environmental use. Yet other preferred compounds can be readily synthesized.

Particularly preferred compounds include: p-iso-butylphenyl chlorosulfate, p-tert-butylphenyl chlorosulfate (4-t-BPCS), p-tert-amylphenyl chlorosulfate, p-tert-cumylphenyl chlorosulfate (4-CPCS), 4-octylphenyl chlorosulfate (4-OPCS), 4-tert-pentylphenyl chlorosulfate (4-PPCS), 4-(1-methylheptyl)phenyl chlorosulfate, methyl chlorosulfate, octyl chlorosulfate, bisphenyl diacid sulfate, p-iso-butylphenyl sulfate, p-tert-butylphenyl sulfate, p-tert-amylphenyl sulfate, p-tert-cumylphenyl sulfate, 4-pentylphenyl sulfate, p-sec-butylphenyl chlorosulfate (4-secBPCS), 4-(1-methylheptyl)phenyl sulfate, methyl sulfate, and octyl sulfate.

Other features and advantages of the invention will be apparent from the following detailed description and claims.

### BRIEF DESCRIPTION OF THE DRAWINGS

FIG. 1 is a diagrammatic representation of the results of marine algae attachment assays measuring the abundance of algal biofilm development on the inert coating RTV-11 compared to biofilm development on RTV-11 with octyl sulfate incorporated into the coating. Relative algal abundance represents the attachment of the marine algae to the tested surface. Error bars indicate 1 standard error of the mean (n=3) for each treatment. The ratio of the optical densities measured at wavelengths 680 nm and 750 nm (A₆₈₀/A₇₅₀) at time O was used as a baseline reference for all samples.

FIG. 2 is a diagrammatic representation of the results of bacterial attachment assays performed with the marine bacterium Oceanosprillum, cultured in the presence and absence of either zosteric acid or methyl sulfate.

FIG. 3 is a diagrammatic representation of the results of bacterial attachment assays performed with the marine bacterium Oceanosprillum, cultured in the presence and absence of either zosteric acid or octyl sulfate.

FIG. 4 is a diagrammatic representation of the results of bacterial attachment assays performed with the bacterium Alteromonas atlantica, performed in the presence and absence of either, zosteric acid, octyl sulfate, or methyl sulfate.

FIG. 5 is a diagrammatic representation of the results of fungal attachment and growth assays using the fungus Aureobasidium pullulans (a shower fungus that stains grout) grown in the presence and absence of zosteric acid, where fungal abundance represents the attachment of A. pullulans to the exposed surface.

FIG. 6 is a diagrammatic representation of the results of agglutination of the bacterium Shewanella putrefaciens induced by the presence of increased amounts of zosteric acid, measured by the percent transmission (% T) of the liquid cultures at wavelength 600 nm. Agglutination is indicated by the concentration-dependent increase in % T of cultures grown in the presence of zosteric acid. In this case, relatively high levels of % T exhibited by the zosteric acid-exposed cultures do not reflect differences in growth, as counts of viable colony forming units exhibited no difference in cell density at eight hours.

FIG. 7 is a diagrammatic representation of data from prothrombin clotting time assays which displays the clotting time of erythrocytes in the presence of high molecular weight heparin compared to the clotting time of erythrocytes in the presence of zosteric acid.

FIG. 8 is a diagrammatic representation of data measuring the effects of zosteric acid on the event of sea urchin egg fertilization. a) Dose dependent effect of zosteric acid on sea urchin fertilization. Percent fertilization represents a comparison of the number of eggs fertilized in the presence of the indicated concentration of zosteric acid, to the number of eggs fertilized under the same conditions, in the absence of zosteric acid. b) Relative effects of coumaric acid, heparin and zosteric acid at equal concentrations (1 mg/mL) on sea urchin egg fertilization.

FIG. 9 is a bar graph plots the fertilization of sea urchin eggs by various concentrations of 4 t-pentyl phenyl chlorosulfact (4-PPCS).

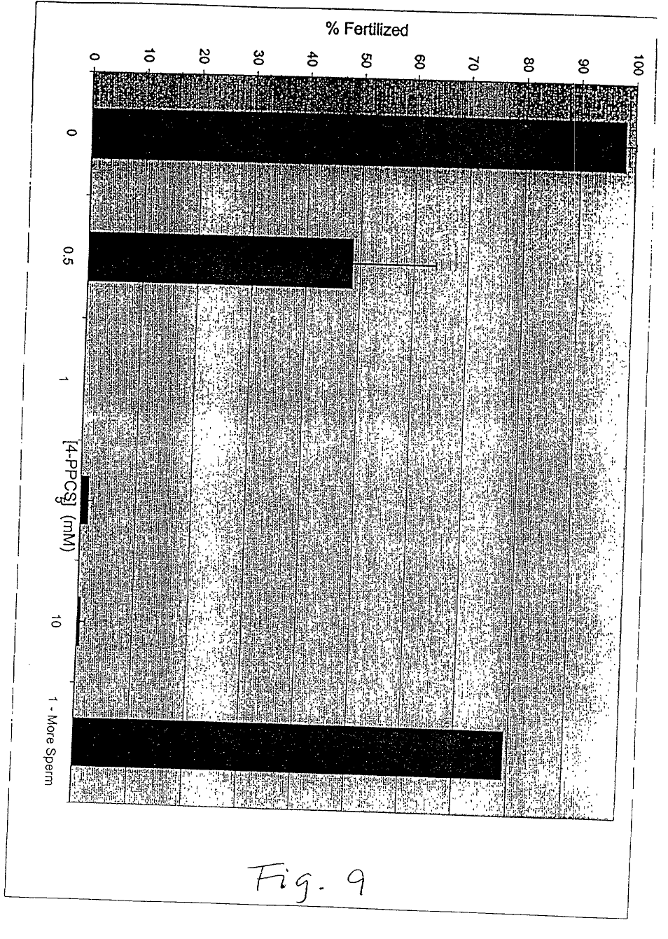

FIG. 10 is a summary graph showing the microbial load (primarily algal fouling) on coupons coated with a KopCoat rosin-based matrix containing different compounds of the invention loaded at about 12.5% (wt/wt). All of the coatings reveal good AF efficacy for the first 20 days of exposure compared to controls, with CPCS performing best. After 20 days loss of coating physical integrity strongly influenced AF performance.

FIG. 11 is a graph of the release rates from a KopCoat rosin-based coating matrix. After the typical; initial “flash” of material release rates were around 100-200 μgcm²d⁻¹.

FIG. 12. is a graph showing hlorosulfate release rates from RTV-11 silicone coupons determined direct UV spectroscopy.

FIG. 13 is a graph showing the time series of microbial biofilm accumulation on RTV-11 silicone coatings loaded with chlorosulfate compounds.

FIG. 14 is a photograph of RTV-11 silicone coupons after 30 days immersion in running seawater.

### DETAILED DESCRIPTION OF THE INVENTION

General

As shown in the following examples, compositions of the invention function to reversibly inhibit the attachment of organisms to surfaces. Although the exact mechanism of action is not known, studies indicate that the mechanism involves binding of the compounds to a sulfate binding moiety on cells. The compound or a functional fragment thereof, must then be released for the inhibitory effect. If permanently tethered to a surface, the compounds and sulfate groups tend to promote rather than inhibit the attachment and growth of organisms on a surface.

By interfering with the attachment of organisms to surfaces, the instant claimed antifouling agents have broad applicability in effectively inhibiting a variety of organisms that contribute to the formation of biofilms or are otherwise involved with biofouling. In addition, the compounds are environmentally safe, as they naturally degrade into carbon dioxide and water, or simple organic acids.

Definitions

For convenience, certain terms employed in the specification, examples, and appended claims are described below.

The term “acylamino” is art-recognized and refers to a moiety that can be represented by the general formula:

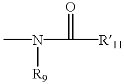

wherein R₉ is as defined above, and R′₁₁ represents a hydrogen, an alkyl, an alkenyl or —(CH₂)ₘ—R₈, where m and R₈ are as defined above.

The terms “alkenyl” and “alkynyl” refer to unsaturated aliphatic groups analogous in length and possible substitution to the alkyls described above, but that comprise a double or triple bond, respectively.

The terms “alkoxyl” or “alkoxy” as used herein refers to an alkyl group, as defined above, having an oxygen radical attached thereto. Representative alkoxyl groups include methoxy, ethoxy, propyloxy, tert-butoxy and the like. An “ether” is two hydrocarbons covalently linked by an oxygen. Accordingly, the substituent of an alkyl that renders that alkyl an ether is or resembles an alkoxyl, such as can be represented by one of —O—alkyl, —O—alkenyl, —O—alkynyl, —O—(CH₂)ₘ—R₈, where m and R₈ are described above.

The term “alkyl” refers to the radical of saturated aliphatic groups, including straight-chain alkyl groups, branched-chain alkyl groups, cycloalkyl (alicyclic) groups, alkyl substituted cycloalkyl groups, and cycloalkyl substituted alkyl groups. In preferred embodiments, a straight chain or branched chain alkyl has 30 or fewer carbon atoms in its backbone (e.g., C₁-C₃₀ for straight chain, C₃-C₃₀ for branched chain), and more preferably 20 or fewer. Likewise, preferred cycloalkyls have from 3-10 carbon atoms in their ring structure, and more preferably have 5, 6 or 7 carbons in the ring structure.

Moreover, the term “alkyl” (or “lower alkyl”) as used throughout the specification and claims is intended to include both “unsubstituted alkyls” and “substituted alkyls”, the latter of which refers to alkyl moieties having substituents replacing a hydrogen on one or more carbons of the hydrocarbon backbone. Such substituents can include, for example, a halogen, a hydroxyl, a carbonyl (such as a carboxyl, an ester, a formyl, or a ketone), a thiocarbonyl (such as a thioester, a thioacetate, or a thioformate), an alkoxyl, a phosphoryl, a phosphonate, a phosphinate, an amino, an amido, an amidine, an imine, a cyano, a nitro, an azido, a sulfhydryl, an alkylthio, a sulfate, a sulfonate, a sulfamoyl, a sulfonamido, a sulfonyl, a heterocyclyl, an aralkyl, or an aromatic or heteroaromatic moiety. It will be understood by those skilled in the art that the moieties substituted on the hydrocarbon chain can themselves be substituted, if appropriate. For instance, the substituents of a substituted alkyl may include substituted and unsubstituted forms of amino, azido, imino, amido, phosphoryl (including phosphonate and phosphinate), sulfonyl (including sulfate, sulfonamido, sulfamoyl and sulfonate), and silyl groups, as well as ethers, alkylthios, carbonyls (including ketones, aldehydes, carboxylates, and esters), —CF₃, —CN and the like. Exemplary substituted alkyls are described below. Cycloalkyls can be further substituted with alkyls, alkenyls, alkoxys, alkylthios, aminoalkyls, carbonyl-substituted alkyls, —CF₃, —CN, and the like.

The term “alkylthio” refers to an alkyl group, as defined above, having a sulfur radical attached thereto. In preferred embodiments, the “alkylthio” moiety is represented by one of —S-alkyl, —S-alkenyl, —S-alkynyl, and —S—(CH₂)ₘ—R₈, wherein m and R₈ are defined above. Representative alkylthio groups include methylthio, ethylthio, and the like.

The term “amido” is art recognized as an amino-substituted carbonyl and includes a moiety that can be represented by the general formula:

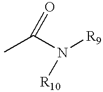

wherein R₉, R₁₀ are as defined above. Preferred embodiments of the amide will not include imides which may be unstable.

The terms “amine” and “amino” are art recognized and refer to both unsubstituted and substituted amines, e.g., a moiety that can be represented by the general formula:

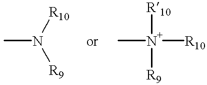

wherein R₉, R₁₀ and R′₁₀ each independently represent a hydrogen, an alkyl, an alkenyl, —(CH₂)ₘ—R₈, or R₉ and R₁₀ taken together with the N atom to which they are attached complete a heterocycle having from 4 to 8 atoms in the ring structure; R₈ represents an aryl, a cycloalkyl, a cycloalkenyl, a heterocycle or a polycycle; and m is zero or an integer in the range of 1 to 8. In preferred embodiments, only one of R₉ or R₁₀ can be a carbonyl, e.g., R₉, R₁₀ and the nitrogen together do not form an imide. In even more preferred embodiments, R₉ and R₁₀ (and optionally R′₁₀) each independently represent a hydrogen, an alkyl, an alkenyl, or —(CH₂)ₘ—R₈. Thus, the term “alkylamine” as used herein means an amine group, as defined above, having a substituted or unsubstituted alkyl attached thereto, i.e., at least one of R₉ and R₁₀ is an alkyl group.

An “aprotic solvent” means a non-nucleophilic solvent having a boiling point range above ambient temperature, preferably from about 25° C. to about 190° C., more preferably from about 80° C. to about 160° C., most preferably from about 80° C. to 150° C., at atmospheric pressure. Examples of such solvents are acetonitrile, toluene, DMF, diglyme, THF or DMSO.

The term “aryl” as used herein includes 5-, 6- and 7-membered single-ring aromatic groups that may include from zero to four heteroatoms, for example, benzene, pyrrole, furan, thiophene, imidazole, oxazole, thiazole, triazole, pyrazole, pyridine, pyrazine, pyridazine and pyrimidine, and the like. Those aryl groups having heteroatoms in the ring structure may also be referred to as “aryl heterocycles” or “heteroaromatics”. The aromatic ring can be substituted at one or more ring positions with such substituents as described above, for example, halogen, azide, alkyl, aralkyl, alkenyl, alkynyl, cycloalkyl, hydroxyl, amino, nitro, sulfhydryl, imino, amido, phosphonate, phosphinate, carbonyl, carboxyl, silyl, ether, alkylthio, sulfonyl, sulfonamido, ketone, aldehyde, ester, heterocyclyl, aromatic or heteroaromatic moieties, —CF₃, —CN, or the like. The term “aryl” also includes polycyclic ring systems having two or more rings in which two or more carbons are common to two adjoining rings (the rings are “fused”) wherein at least one of the rings is aromatic, e.g., the other rings can be cycloalkyls, cycloalkenyls, cycloalkynyls, aryls and/or heterocyclyls.

The term “arylalkyl”, as used herein, refers to an alkyl group substituted with an aryl group (e.g., an aromatic or heteroaromatic group).

The term “bioavailable” is meant to refer to an appropriate location or orientation of a compound for performance of the compounds' bioactivity.

The term “biofilm” refers to an accumulation of organisms on a surface. A mature biofilm can comprise a colony of microorganisms resident upon a surface surrounded by an exopolysaccharide.

“biofouling organisms” refer to organisms or cells thereof that attach to surfaces and cause or contribute to biofouling or biofilm formation. These organisms can live in a wide range of environments, but most typically are in contact with a liquid or otherwise moist or humid environment. Biofouling organisms can live in either high or low flow aqueous environments, over a broad range of temperatures and pHs. Included are natural and man-made aquatic environments, including salt water, fresh water and brackish water. Also included are semi-aqueous or periodically aqueous environments which expose surfaces to high humidity, precipitation, or periodic flooding. Biofouling organisms can attach to surfaces at various stages of their life cycle, including larval stages, as well as adult. Examples of biofouling organisms include: macrofoulers, such as polychaetes colonial tunicates, and other sessil invertebrates including barnacles, bacteria, (gram negative and gram positive), algae, protists and fungi.

“Biofilm resistant” or “antifouling” refers to inhibition of attachment and/or growth of a biofouling organism.

A “biofoul or biofilm resistant coating” refers to any coating or surface that inhibits attachment and /or growth of biofouling organisms

The term “carbocycle”, as used herein, refers to an aromatic or non-aromatic ring in which each atom of the ring is carbon.

The term “carbonyl” is art recognized and includes such moieties as can be represented by the general formula:

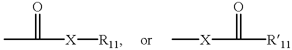

wherein X is a bond or represents an oxygen or a sulfur, and R₁₁ represents a hydrogen, an alkyl, an alkenyl, —(CH₂)ₘ—R₈ or a pharmaceutically acceptable salt, R′₁₁ represents a hydrogen, an alkyl, an alkenyl or —(CH₂)ₘ—R₈, where m and R₈ are as defined above. Where X is an oxygen and R₁₁ or R′₁₁ is not hydrogen, the formula represents an “ester”. Where X is an oxygen, and R₁₁ is as defined above, the moiety is referred to herein as a carboxyl group, and particularly when R₁₁ is a hydrogen, the formula represents a “carboxylic acid”. Where X is an oxygen, and R′₁₁ is hydrogen, the formula represents a “formate”. In general, where the oxygen atom of the above formula is replaced by sulfur, the formula represents a “thiolcarbonyl” group. Where X is a sulfur and R₁₁ or R′₁₁ is not hydrogen, the formula represents a “thiolester.” Where X is a sulfur and R₁₁ is hydrogen, the formula represents a “thiolcarboxylic acid.” Where X is a sulfur and R₁₁′ is hydrogen, the formula represents a “thiolformate.” On the other hand, where X is a bond, and R₁₁ is not hydrogen, the above formula represents a “ketone” group. Where X is a bond, and R₁₁ is hydrogen, the above formula represents an “aldehyde” group.

“Contacting” as used herein refers to any means for providing the compounds of the invention to a surface to be protected from biofouling. Contacting can include spraying, wetting, immersing, dipping, painting, bonding or adhering or otherwise providing a surface with a compound of the invention.

A “coating” refers to any temporary, semipermanent or permanent layer or covering. A coating can be a gas, vapor, liquid, paste, semi-solid or solid. In addition a coating can be applied as a liquid and solidify into a hard coating. Examples of coatings include polishes, surface cleaners, caulks, adhesives, finishes, paints, waxes polymerizable compositions (including phenolic resins, silicone polymers, chlorinated rubbers, coal tar and epoxy combinations, epoxy resin, polyamide resins, vinyl resins, elastomers, acrylate polymers, fluoropolymers, polyesters and polyurethanes, latex). Silicone resins, silicone polymers (e.g. RTV polymers) and silicone heat cured rubbers are suitable coatings for use in the invention and described for example in the Encyclopedia of Polymer Science and Engineering (1989) 15: 204 et seq. Coatings can be ablative or dissolvable, so that the dissolution rate of the matrix controls the rate at which AF agents are delivered to the surface. Coatings can also be non-ablative, and rely on diffusion principles to deliver an AF agent to the surface. Non-ablative coatings can be porous or non-porous. A coating containing an AF agent freely dispersed in a polymer binder is referred to as “monolithic” coating. Elasticity can be engineered into coatings to accommodate pliability, e.g. swelling or shrinkage, of the surface to be coated.

The phrase “effective amount” refers to an amount of the disclosed antifouling compounds that significantly reduces the number of organisms that attach to a defined surface (cells/mm²) relative to the number that attach to an untreated surface. Particularly preferred are amounts that reduce the number of organisms that attach to the surface by a factor of at least 2. Even more preferred are amounts that reduce the surface attachment of organisms by a factor of 4, more preferably by a factor of 6, 8, 10, 15, 20 or more.

The phrase “electron-withdrawing group” is recognized in the art, and denotes the tendency of a substituent to attract valence electrons from neighboring atoms, i.e., the substituent is electronegative with respect to neighboring atoms. A quantification of the level of electron-withdrawing capability is given by the Hammett sigma (σ) constant. This well known constant is described in many references, for instance, J. March, Advanced Organic Chemistry, McGraw Hill Book Company, New York, (1977 edition) pp. 251-259. The Hammett constant values are generally negative for electron donating groups (σ[P]=−0.66 for NH₂) and positive for electron withdrawing groups (σ[P]=0.78 for a nitro group), σ[P] indicating para substitution. Exemplary electron-withdrawing groups include nitro, ketone, aldehyde, sulfonyl, trifluoromethyl, —CN, chloride, and the like. Exemplary electron-donating groups include amino, methoxy, and the like.

The term “half-life” refers to the amount of time required for half of a compound to be eliminated or degraded by natural processes.

The term “heteroatom” as used herein means an atom of any element other than carbon or hydrogen. Preferred heteroatoms are nitrogen, oxygen, sulfur and phosphorous.

The terms “heterocyclyl” or “heterocyclic group” refer to 3- to 10-membered ring structures, more preferably 3- to 7-membered rings, whose ring structures include one to four heteroatoms. Heterocycles can also be polycycles. Heterocyclyl groups include, for example, thiophene, thianthrene, furan, pyran, isobenzofuran, chromene, xanthene, phenoxathiin, pyrrole, imidazole, pyrazole, isothiazole, isoxazole, pyridine, pyrazine, pyrimidine, pyridazine, indolizine, isoindole, indole, indazole, purine, quinolizine, isoquinoline, quinoline, phthalazine, naphthyridine, quinoxaline, quinazoline, cinnoline, pteridine, carbazole, carboline, phenanthridine, acridine, perimidine, phenanthroline, phenazine, phenarsazine, phenothiazine, furazan, phenoxazine, pyrrolidine, oxolane, thiolane, oxazole, piperidine, piperazine, morpholine, lactones, lactams such as azetidinones and pyrrolidinones, sultams, sultones, and the like. The heterocyclic ring can be substituted at one or more positions with such substituents as described above, as for example, halogen, alkyl, aralkyl, alkenyl, alkynyl, cycloalkyl, hydroxyl, amino, nitro, sulfhydryl, imino, amido, phosphonate, phosphinate, carbonyl, carboxyl, silyl, ether, alkylthio, sulfonyl, ketone, aldehyde, ester, a heterocyclyl, an aromatic or heteroaromatic moiety, —CF₃, —CN, or the like.

Unless the number of carbons is otherwise specified, “lower alkyl” as used herein means an alkyl group, as defined above, but having from one to ten carbons, more preferably from one to six carbon atoms in its backbone structure. Likewise, “lower alkenyl” and “lower alkynyl” have similar chain lengths. Preferred alkyl groups are lower alkyls. In preferred embodiments, a substituent designated herein as alkyl is a lower alkyl.

As used herein, the term “nitro” means —NO₂; the term “halogen” designates —F, —Cl, —Br or —I; the term “sulfhydryl” means —SH; the term “hydroxyl” means —OH; and the term “sulfonyl” means —SO₂—.

The terms ortho, meta and para apply to 1,2-, 1,3- and 1,4-disubstituted benzenes, respectively. For example, the names 1,2-dimethylbenzene and ortho-dimethylbenzene are synonymous.

A “phosphoryl” can in general be represented by the formula:

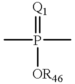

wherein Q₁ represented S or O, and R₄₆ represents hydrogen, a lower alkyl or an aryl. When used to substitute, e.g., an alkyl, the phosphoryl group of the phosphorylalkyl can be represented by the general formula:

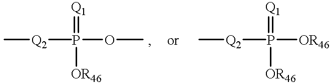

wherein Q₁ represented S or O, and each R₄₆ independently represents hydrogen, a lower alkyl or an aryl, Q₂ represents O, S or N. When Q₁ is an S, the phosphoryl moiety is a “phosphorothioate”.

A “polar, aprotic solvent” means a polar solvent as defined above which has no available hydrogens to exchange with the compounds of this invention during reaction, for example DMF, acetonitrile, diglyme, DMSO, or THF.

A “polar solvent” means a solvent which has a dielectric constant (ε) of 2.9 or greater, such as DMF, THF, ethylene glycol dimethyl ether (DME), DMSO, acetone, acetonitrile, methanol, ethanol, isopropanol, n-propanol, t-butanol or 2-methoxyethyl ether. Preferred solvents are DMF, DME, NMP, and acetonitrile.

The terms “polycyclyl” or “polycyclic group” refer to two or more rings (e.g., cycloalkyls, cycloalkenyls, cycloalkynyls, aryls and/or heterocyclyls) in which two or more carbons are common to two adjoining rings, e.g., the rings are “fused rings”. Rings that are joined through non-adjacent atoms are termed “bridged” rings. Each of the rings of the polycycle can be substituted with such substituents as described above, as for example, halogen, alkyl, aralkyl, alkenyl, alkynyl, cycloalkyl, hydroxyl, amino, nitro, sulfhydryl, imino, amido, phosphonate, phosphinate, carbonyl, carboxyl, silyl, ether, alkylthio, sulfonyl, ketone, aldehyde, ester, a heterocyclyl, an aromatic or heteroaromatic moiety, —CF₃, —CN, or the like.

The phrase “protecting group” as used herein means temporary modifications of a potentially reactive functional group which protect it from undesired chemical transformations. Examples of such protecting groups include esters of carboxylic acids, silyl ethers of alcohols, and acetals and ketals of aldehydes and ketones, respectively. The field of protecting group chemistry has been reviewed (Greene, T. W.; Wuts, P. G. M. Protective Groups in Organic Synthesis, 2^{nd} ed.; Wiley: New York, 1991).

“Release rate” or “flux” refers to the rate of delivery or diffusion of a compound to and ultimately from a surface. The release rate may be constant or sustained over a period of time or may be variable. However, constant, controlled or sustained release rates are generally preferred. Steady state or sustained release may be effected by use of a reservoir membrane (i.e. a two layer coating in which one layer contains the active agent and the other creates a membrane through which the active agent can be released). The active agent could alternatively be microencapsulated within any of a variety of matrices for sustained release. Release rates of at least about 100, 150, 200 or 300 μgcm⁻²d^{-1,} may be useful for temporary uses or uses that require reapplication. For more sustained applications, preferred release rates of less than about 100 μgcm⁻²d⁻¹, more preferably less than about 75, less than about 50, less than about 25, less than about 10 or less than about 5.

The term “soluble” refers to the ability to be loosened or dissolved.

As used herein, the term “substituted” is contemplated to include all permissible substituents of organic compounds. In a broad aspect, the permissible substituents include acyclic and cyclic, branched and unbranched, carbocyclic and heterocyclic, aromatic and nonaromatic substituents of organic compounds. Illustrative substituents include, for example, those described hereinabove. The permissible substituents can be one or more and the same or different for appropriate organic compounds. For purposes of this invention, the heteroatoms such as nitrogen may have hydrogen substituents and/or any permissible substituents of organic compounds described herein which satisfy the valencies of the heteroatoms. This invention is not intended to be limited in any manner by the permissible substituents of organic compounds.

It will be understood that “substitution” or “substituted with” includes the implicit proviso that such substitution is in accordance with permitted valence of the substituted atom and the substituent, and that the substitution results in a stable compound, e.g., which does not spontaneously undergo transformation such as by rearrangement, cyclization, elimination, etc.

The term “sulfate” is art recognized and includes a moiety that can be represented by the general formula:

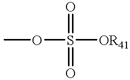

in which R₄₁ is as defined above.

A “sulfate binding moiety” refers to a moiety that is capable of binding or otherwise associating with a sulfate or sulfonate group.

The term “sulfonate” is art recognized and includes a moiety that can be represented by the general formula:

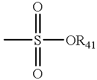

in which R₄₁ is an electron pair, hydrogen, alkyl, cycloalkyl, or aryl.

The terms “sulfoxido” or “sulfinyl”, as used herein, refers to a moiety that can be represented by the general formula:

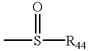

in which R₄₄ is selected from the group consisting of hydrogen, alkyl, alkenyl, alkynyl, cycloalkyl, heterocyclyl, aralkyl, or aryl.

Analogous substitutions can be made to alkenyl and alkynyl groups to produce, for example, aminoalkenyls, aminoalkynyls, amidoalkenyls, amidoalkynyls, iminoalkenyls, iminoalkynyls, thioalkenyls, thioalkynyls, carbonyl-substituted alkenyls or alkynyls.

The term “surface” as used herein, refers to any interface between an object and a fluid environment, which permits at least intermittent contact between the object and the fluid environment. A surface, as understood herein, further provides a plane whose mechanical structure, without further treatment, is compatible with the adherence of microorganisms. Surfaces compatible with biofilm formation may be smooth or irregular. Fluids contacting the surfaces can be stagnant or flowing, and can flow intermittently or continuously, with laminar or turbulent or mixed rheologies. A surface upon which a biofilm can form can be dry at times with sporadic fluid contact, or can have any degree of fluid exposure including total immersion. Fluid contact with the surface can take place via aerosols or other means for air-borne fluid transmission. Examples of appropriate surfaces include: water intake and output systems (e.g. pipes), water cooling towers, heat exchangers, pools, fountains, wells, hulls of boats and ships, sensors, underwater windows, fishing netting, buoys, pilings, and other building materials, comprised of virtually any natural or synthetic material, that are exposed to moist or wet environments.

“Sustained release” or “controlled release refers to a relatively constant or prolonged release of a compound of the invention from a surface. This can be accomplished through the use of diffusional systems, including reservoir devices in which a core of a compound of the invention is surrounded by a porous membrane or layer, and also matrix devices in which the compound is distributed throughout an inert matrix. Materials which may be used to form lo reservoirs or matrices include silicones, acrylates, methacrylates, vinyl compounds such as polyvinyl chloride, olefins such as polyethylene or polypropylene, fluoropolymers such as polytetrafluorethylene, and polyesters such as terephthalates. The diffusional systems may be molded into a film or other layer material which is then placed in adherent contact with the structure intended for underwater use. Alternatively, the compounds of the invention may be mixed with a resin, e.g., polyvinyl chloride and then molded into a formed article, which integrally incorporates the compound to form a structure having a porous matrix which allows diffusion of the compound, or a functional portion thereof, into the surrounding environment. Microencapsulation techniques can also be used to maintain a sustained focal release of a compound of the invention. Microencapsulation may also be used for providing improved stability. The encapsulated product can take the form of for example, spheres, aggregates of core material embedded in a continuum of wall material, or capillary designs. The core material of a microcapsule containing a compound of the invention may be in the form of a liquid droplet, an emulsion, a suspension of solids, a solid particle, or a crystal. The skilled artisan will be aware of numerous materials suitable for use as microcapsule coating materials, including, but not limited to, organic polymers, hydrocolloids, lipids, fats, carbohydrates, waxes, metals, and inorganic oxides. Silicone polymers are the most preferred microcapsule coating material for treatment of surfaces. Microencapsulation techniques are well known in the art and are described in the Encyclopedia of Polymer Science and Engineering, Vol. 9, pp. 724 et seq. (1989) hereby incorporated by reference.

The abbreviations Me, Et, Ph, Tf, Nf, Ts, Ms, and dba represent methyl, ethyl, phenyl, trifluoromethanesulfonyl, nonafluorobutanesulfonyl, p-toluenesulfonyl, methanesulfonyl, and dibenzylideneacetone, respectively. A more comprehensive list of the abbreviations utilized by organic chemists of ordinary skill in the art appears in the first issue of each volume of the Journal of Organic Chemistry; this list is typically presented in a table entitled Standard List of Abbreviations. The abbreviations contained in said list, and all abbreviations utilized by organic chemists of ordinary skill in the art are hereby incorporated by reference.

For purposes of this invention, the chemical elements are identified in accordance with the Periodic Table of the Elements, CAS version, Handbook of Chemistry and Physics, 67th Ed., 1986-87, inside cover. Also for purposes of this invention, the term “hydrocarbon” is contemplated to include all permissible compounds having at least one hydrogen and one carbon atom. In a broad aspect, the permissible hydrocarbons include acyclic and cyclic, branched and unbranched, carbocyclic and heterocyclic, aromatic and nonaromatic organic compounds which can be substituted or unsubstituted.

Compositions of the Invention

In certain embodiments, the compositions of the present invention comprise an antifouling compound represented by general structure 1:

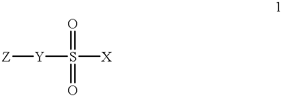

wherein

X represents —OH, —O(aryl), —O(acyl), —O(sulfonyl), —CN, F, Cl, or Br;

Y represents O, S, Se, or NR;

Z represents optionally substituted alkyl, heteroalkyl, cycloalkyl, heterocycloalkyl, aryl, heteroaryl, aralkyl, heteroaralkyl, or —(CH₂)ₘ—R₈₀;

R represents independently for each occurrence hydrogen, alkyl, heteroalkyl, aryl, heteroaryl, aralkyl, heteroaralkyl, or —(CH₂)ₘ—R₈₀;

R₈₀ represents independently for each occurrence aryl, cycloalkyl, cycloalkenyl, heterocyclyl, or polycyclyl; and

m is an integer in the range 0 to 8 inclusive.

Particularly stable compounds are represented by general structure 1 and the attendant definitions, wherein X represents —OH, F, Cl, or Br.

In other preferred embodiments, the compositions of the present invention comprise an anti-fouling compound represented by general structure 1 and the attendant definitions, wherein Y represents O.

In certain embodiments, the compositions of the present invention comprise an antifouling compound represented by general structure 1 and the attendant definitions, wherein Z represents optionally substituted alkyl, aryl, or —(CH₂)ₘ—R₈₀.

In certain embodiments, the compositions of the present invention comprise an antifouling compound represented by general structure 1 and the attendant definitions, wherein Z represents optionally substituted alkylphenyl, heteroalkylphenyl, arylphenyl, or heteroarylphenyl.

In certain embodiments, the compositions of the present invention comprise an antifouling compound represented by general structure 1 and the attendant definitions, wherein Z represents methyl, octyl, 4-(2-methylpropyl)phenyl, 4-(1,1-dimethylethyl)phenyl, 4-(1,1-dimethylpropyl)phenyl, 4-pentylphenyl, 4-(1-methyl-1-phenylethyl)phenyl, or 4-(1-methylheptyl)phenyl.

In certain embodiments, the compositions of the present invention comprise an antifouling compound represented by general structure 1 and the attendant definitions, wherein R represents H or alkyl.

In certain embodiments, the compositions of the present invention comprise an antifouling compound represented by general structure 1 and the attendant definitions, wherein X represents —OH, F, Cl, or Br; and Y represents O.

In certain embodiments, the compositions of the present invention comprise an antifouling compound represented by general structure 1 and the attendant definitions, wherein X represents —OH or Cl; and Y represents O.

In certain embodiments, the compositions of the present invention comprise an antifouling compound represented by general structure 1 and the attendant definitions, wherein X represents —OH, F, Cl, or Br; and Z represents optionally substituted alkyl, aryl, or —(CH₂)ₘ—R₈₀.

In certain embodiments, the compositions of the present invention comprise an antifouling compound represented by general structure 1 and the attendant definitions, wherein X represents —OH or Cl; and Z represents optionally substituted alkyl, aryl, or —(CH₂)ₘ—R₈₀.

In certain embodiments, the compositions of the present invention comprise an antifouling compound represented by general structure 1 and the attendant definitions, wherein X represents —OH, F, Cl, or Br; and Z represents optionally substituted alkylphenyl, heteroalkylphenyl, arylphenyl, or heteroarylphenyl.

In certain embodiments, the compositions of the present invention comprise an antifouling compound represented by general structure 1 and the attendant definitions, wherein X represents —OH or Cl; and Z represents optionally substituted alkylphenyl, heteroalkylphenyl, arylphenyl, or heteroarylphenyl.

In certain embodiments, the compositions of the present invention comprise an antifouling compound represented by general structure 1 and the attendant definitions, wherein X represents —OH, F, Cl, or Br; and Z represents methyl, octyl, 4-(2-methylpropyl)phenyl, 4-(1,1-dimethylethyl)phenyl, 4-(1,1-dimethylpropyl)phenyl, 4-pentylphenyl, 4-(1-methyl-1-phenylethyl)phenyl, or 4-(1-methylheptyl)phenyl.

In certain embodiments, the compositions of the present invention comprise an antifouling compound represented by general structure 1 and the attendant definitions, wherein X represents —OH or Cl; and Z represents methyl, octyl, 4-(2-methylpropyl)phenyl, 4-(1,1-dimethylethyl)phenyl, 4-(1,1-dimethylpropyl)phenyl, 4-pentylphenyl, 4-(1-methyl-1-phenylethyl)phenyl, or 4-(1-methylheptyl)phenyl.

In certain embodiments, the compositions of the present invention comprise an antifouling compound represented by general structure 1 and the attendant definitions, wherein Y represents O; and Z represents optionally substituted alkyl, aryl, or —(CH₂)ₘ—R₈₀.

In certain embodiments, the compositions of the present invention comprise an antifouling compound represented by general structure 1 and the attendant definitions, wherein Y represents O; and Z represents optionally substituted alkylphenyl, heteroalkylphenyl, arylphenyl, or heteroarylphenyl.

In certain embodiments, the compositions of the present invention comprise an antifouling compound represented by general structure 1 and the attendant definitions, wherein Y represents O; and Z represents methyl, octyl, 4-(2-methylpropyl)phenyl, 4-(1,1-dimethylethyl)phenyl, 4-(1,1-dimethylpropyl)phenyl, 4-pentylphenyl, 4-(1-methyl-1-phenylethyl)phenyl, or 4-(1-methylheptyl)phenyl.

In certain embodiments, the compositions of the present invention comprise an antifouling compound represented by general structure 1 and the attendant definitions, wherein X represents —OH, F, Cl, or Br; Y represents O; and Z represents optionally substituted alkyl, aryl, or —(CH₂)ₘ—R₈₀.

In certain embodiments, the compositions of the present invention comprise an antifouling compound represented by general structure 1 and the attendant definitions, wherein X represents —OH or Cl; Y represents O; and Z represents optionally substituted alkyl, aryl, or —(CH₂)ₘ—R₈₀.

In certain embodiments, the compositions of the present invention comprise an antifouling compound represented by general structure 1 and the attendant definitions, wherein X represents —OH, F, Cl, or Br; Y represents O; and Z represents optionally substituted alkylphenyl, heteroalkylphenyl, arylphenyl, or heteroarylphenyl.

In certain embodiments, the compositions of the present invention comprise an antifouling compound represented by general structure 1 and the attendant definitions, wherein X represents —OH or Cl; Y represents O; and Z represents optionally substituted alkylphenyl, heteroalkylphenyl, arylphenyl, or heteroarylphenyl.

In certain embodiments, the compositions of the present invention comprise an antifouling compound represented by general structure 1 and the attendant definitions, wherein X represents —OH, F, Cl, or Br; Y represents O; and Z represents methyl, octyl, 4-(2-methylpropyl)phenyl, 4-(1,1-dimethylethyl)phenyl, 4-(1,1-dimethylpropyl)phenyl, 4-pentylphenyl, 4-(1-methyl-1-phenylethyl)phenyl, or 4-(1-methylheptyl)phenyl.

In certain embodiments, the compositions of the present invention comprise an antifouling compound represented by general structure 1 and the attendant definitions, wherein X represents —OH or Cl; Y represents O; and Z represents methyl, octyl, 4-(2-methylpropyl)phenyl, 4-(1,1-dimethylethyl)phenyl, 4-(1,1-dimethylpropyl)phenyl, 4-pentylphenyl, 4-(1-methyl-1-phenylethyl)phenyl, or 4-(1-methylheptyl)phenyl.

One of skill in the art can synthesize the compounds described above by standard chemical syntheses. The synthesis of certain of the compounds described herein is via the scheme Z—OH in the presence of SO₂Cl₂ and pyrimidine at −78° C. in ethanol yields Z—O—SO₂Cl. One of skill in the art will also recognize that the compositions of the invention can be varied as required to optimize the overall chemical properties of the particular compound for specific uses, while retaining the AF activity. For example, the length of an alkyl chain can be extended or shortened to control the rate of dissolution of the compound from a structure or a coating. Alternatively, additional functional groups can be added to the alkyl chain to further vary the chemical nature of the molecule.

Antifouling Coating Compositions

Antifouling coating compositions of the present invention can also contain a paint base such as vinyl, acrylic, and alkyd resin bases. They can also contain a pigment such as titanium dioxide, a thickener such as bentonite, fillers such as aluminum silicate and calcium silicate, and driers such as cobalt naphthenate and manganese naphthenate. They may also contain solvents or thinners such as mineral spirits, naphtha, benzene, toluene, methylethyl ketone, and the like.

The binder to filler ratio in the coatings of the present invention depends upon the density of the filler. For example, with a light filler such as china clay or titanium dioxide, the coating preferably contains from about 10 to about 85% binder. For a dense filler such as zinc dust, the coating contains from only about 5% up to about 50% binder. More preferably, a coating containing zinc as a filler comprises from about 20 to about 40% by weight binder based on the total weight of the coating so the coating is strong, durable, adherent, biologically active, and has anticorrosion properties.

Conventional fillers can be used in coatings of the present invention. These include silica powder, talc (magnesium silicate), china clay (aluminum silicate), Wollastonite (calcium silicate), barytes (barium sulfate), barium metaborate, and the like. Pigments such as iron oxide, chrome yellow, and chrome green may also be used. Organic dyes may also be used to color the product. Zinc oxide can be used to aid film hardening and resistance to growth of algae. Anticorrosion-antifouling coatings useful for direct application over a clean steel surface can be prepared by using a biologically active polysiloxane binder and a metallic filler such as zinc. Copper and cuprous oxide can be used as fillers to enhance the antifouling properties of a coating.

The rate of dissolution of a coating of the present invention can be retarded by incorporating a hydrophobic organic retarder in the coating. The retarder can be a hydrophobic organic compound which has a solubility in seawater at 25° C. of not more than 5 parts per million by weight, is miscible with the other components of the coating composition and has a negligible vapour pressure at 25° C. Examples of such hydrophobic organic retarders are silicone fluids, for example, methyl phenyl silicone fluid DC550 sold by Dow Corning Ltd., chlorinated diphenyl, for example Aroclor 1254 sold by Monsanto Ltd., chlorinated paraffin wax, for example Cereclor 48 sold by I. C. I. Ltd., and low-molecular weight polybutenes such as Hyvis 05 sold by B. P. Ltd. The hydrophobic organic retarder should be emulsified into the paint composition.

As an alternative to using a hydrophobic organic retarder the paint composition can contain a water-insoluble pigment which does not react with, or dissolve in, seawater, as well as a seawater reactive pigment. Examples of such unreactive and insoluble pigments are titanium dioxide and ferric oxide. The unreactive pigment, if used, preferably forms from 5-40 percent by weight of the total pigment component of the paint. Some coloring pigments such as carbon black and phthalocyanine green are also insoluble and unreactive with seawater. These coloring pigments are generally used in amounts of less than 4 percent by weight of the total pigment. They are included in the insoluble and reactive pigment when calculating the proportion that this forms of the total pigment component. Other insoluble materials often used in marine paint compositions are silica and clays such as bentonite, which are used to control the flow and settling properties of the paint. These materials used to control the flow and settling properties are not regarded as pigments and are not included when calculating the proportions of the seawater reactive and unreactive pigments.

The proportion of solvent in the composition is subject to rather wide variation and is determined largely by the desired viscosity of the composition to permit application to substrates by spraying, brushing, or the like. If the proportion of solvent is less than about 18% by weight, the viscosity of the composition may be so high that application to substrates in coatings of reasonable thickness is rather difficult. Leveling to obtain a smooth coating may also be inhibited. If the composition has more than about 52% by weight of solvent, application of coatings of reasonable thickness can be limited by sagging or running. Preferably, the solvent is present in the range of from about 24 to 36% by weight. It is found that such a proportion of solvent with the preferred resin compositions and other marine paint additives hereinafter described provides a viscosity range quite suitable for application to substrates by brushing and/or spraying.

A variety of other ingredients can form the balance of the composition in the range of from about 10 to 65% by weight. Such additional ingredients are conventional additives, e.g., to marine paints, and are employed for modifying the properties of the coating composition or providing additional antifouling toxicity. It is desirable to include a slightly water soluble resin in the composition for enhancing gradual dissolution and ablation of the coating. Addition of such resins that are slightly soluble in seawater enhances the microporosity of the coating and can help control the hydrolysis of the coating for maintaining antifouling characteristics over a long lifetime. Preferably, the water soluble resin is water white rosin, since it is economical, easily blended into the composition, and quite suitable in stability and water solubility. Other slightly soluble resins can be substituted such as hydroxy ethyl methacrylate, polyvinyl acetate, polyvinyl alcohol, or the like.

The proportion of water soluble resin in the composition depends on the degree of solubility of the resin and desired rate of ablation and penetration of water into the coating. For example, when rosin is the seawater soluble portion of the composition, it is preferably present in the range of from about 1 to 10% by weight, and most preferably in the range of from about 3 to 6% by weight. If the rosin is present at less than about 1% by weight, the coating may become passivated, and antifouling characteristics degraded, particularly when copper or copper salts are included in the composition. Rosin content of more than about 10% by weight leads to excessive ablation and short lifetime of such a coating. Preferably, rosin is present in the range of from about 3 to 6% by weight, to provide a good balance of coating lifetime and water penetration to provide long antifouling activity.

It is highly desirable to include a thixotropic agent such as alcohol swellable clay, talc, or colloidal silica. Such conventional thickeners are widely used in paint compositions for modifying viscosity and obtaining paints that can be sprayed or brushed to provide a coating of reasonable thickness without sagging or running. An exemplary thickening agent particularly useful is dimethyl dioctodecyl ammonium bentonite available from the Baroid Division of National Lead Company, Houston, Tex., as Bentone 34. Preferably the thickener is present in the composition in the range of from about 0.5 to 4% by weight and most preferably in the range of from about 0.5 to 2.0% by weight, as is conventional in paint compositions.

The present invention is further illustrated by the following examples, which should not be construed as limiting in any way. The contents of all cited references including literature references, issued patents and published patent applications as cited throughout this patent application are hereby expressly incorporated by reference.

### EXAMPLES

### Example 1

### Inhibition of Surface Attachment of Marine Bacteria by Alkyl Sulfates

Octyl sulfate is an alkyl sulfate surfactant with extensive industrial applications, and is manufactured by several large chemical companies. To investigate potential AF properties of the sulfate ester octyl sulfate, it was incorporated into an inert coating material that was then coated onto a surface to be exposed to conditions that support the formation of marine algal biofilms.

### Materials and Methods

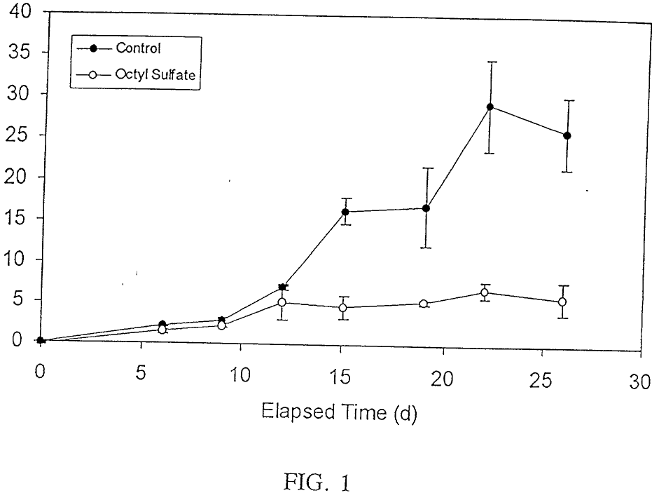

A 30% (w/v) solution of octyl sulfate in water (Stepan Chemical Co.) was evaporated to dryness under a stream of room temperature air, to recover pure octyl sulfate (FIG. 1). The dry octyl sulfate was incorporated into RTV-11 silicone polymer at a loading of 25% (wt/wt) (RTV-11 silicone, catalyst and primer obtained from General Electric). The mixture was applied to three glass slides previously primed with silicone primer, and allowed to cure to dryness. Three primed glass slides coated with pure RTV-11 served as agent-free controls. After complete drying, the absorption properties of each slide were measured using a Shimadzu UV-2101 spectrophotometer fitted with an integrating sphere. Slides were then placed in a tank of running raw seawater and allowed to incubate outdoors in natural sunlight for 26 days. Water temperature was nominally 15° C. Spectrophotometric determination of biofilm accumulation was measured on each slide periodically. Relative algal biomass was calculated as the ratio of absorption at 680 nm, contributed by chlorophyll a, to that at 750 nm, a wavelength not absorbed by chlorophyll, to correct for differences in turbidity and scattering properties of the different slides.

### Results

As shown in FIG. 1, octyl sulfate incorporated into RTV-11 silicone, and then coated onto glass slides, significantly inhibited the formation of natural marine algal biofilms in natural seawater. After 26 days of incubation in running seawater, algal biofilm development on the octyl sulfate containing coatings was five fold less than that of controls lacking octyl sulfate, indicating that octyl sulfate possesses strong AF activity.

Studies were performed to evaluate the ability of the sulfate ester molecules octyl sulfate and methyl sulfate, to inhibit adhesion of the marine bacteriums Oceanosprillum and Alteromonas atlantica to glass surfaces.

### Materials and Methods

Oceanosprillum adhesion test Each test consisted of a control set (with no sulfate esters) and sample sets containing the test molecules. The first test group consisted of a control sample set, a zosteric acid (5 mM) sample set, and an octyl sulfate (5 mM) sample set. The second test group consisted of a control sample set, a zosteric acid (5 mM) sample set, and a methyl sulfate (5 mM) sample set. Sample sets consisted of five 50 mL sterile centrifuge tubes, with each tube containing a glass microscope slide, 50 ml of artificial seawater (ASTM—American Society for testing and materials) with the dissolved sulfate ester, inoculated with an Oceanosprillum culture at 1×10⁶ cells/mL. Sample sets were incubated at 23° C., with shaking so that the surface of the slides were horizontal. Over a 6-hour period, individual tubes were taken from the sample sets and tested for microbial adhesion.

Alteromonas atlantica adhesion tests. The tests consisted of a control sample set, a zosteric acid (5 mM) sample set, an octyl sulfate (5 mM) sample set, and a methyl sulfate (5 mM) set. A sample set consisted of six 60 mL sterile centrifuge tubes. Each tube contained a glass microscope slide and 50 mL of modified ASTM seawater (American Society for Testing and Materials (1986) D1141-86, ASTM, Philadelphia, Pa.) with dissolved agent, inoculated with Alteromonas atlantica culture to an initial cell density of 1×10⁶ cells/mL. The modified seawater consisted of normal ASTM seawater ingredients, however the carbon source glycerol, was only 1000th the normal strength, 0.1 L/L instead of 100 L/L, and was void of an amino acid source (casamino acids), in order to allow enough carbon for attachment, but not for significant cell growth.

Determination of bacterial adhesion. Samples were removed from the shaker and 1 mL of 50× acridine orange stain (0.5 g/L acridine powder in water) was added to the tube. The stain was allowed to react for 4 minutes. The slides were then removed and fitted with a long cover slip and immediately counted with an epifluorescent microscope fitted with a 100× (oil) objective lens on the under side of the slide. The size of the counting field was 10×10 μm. A total of 20 counts per slide were performed and averaged to yield the number of cells per μm², which was in turn converted to cells per mm². Error was assigned at 10% which is the standard accepted error for direct counting of bacterial cells.

### Results

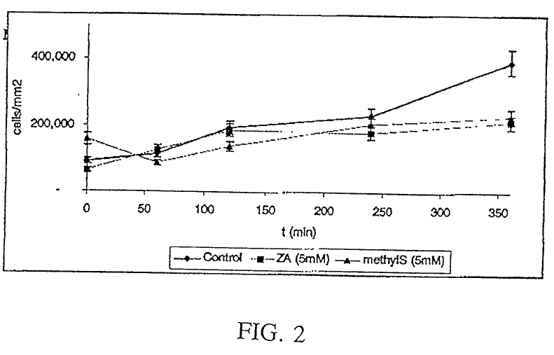

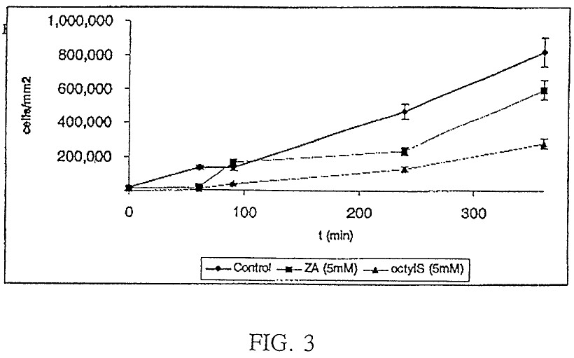

As shown in FIG. 2, the presence of octyl sulfate or methyl sulfate in the medium significantly reduced bacterial adhesion to the glass slides when compared to controls in which no sulfate ester molecule was present. Methyl sulfate inhibited Oceanosprillum adhesion to an extent similar to the proven AF agent zosteric acid, with each compound promoting roughly a two fold reduction in bacterial attachment, relative to control. As shown in FIG. 3, octyl sulfate inhibited Oceanosprillum adhesion to an even greater extent than zosteric acid.

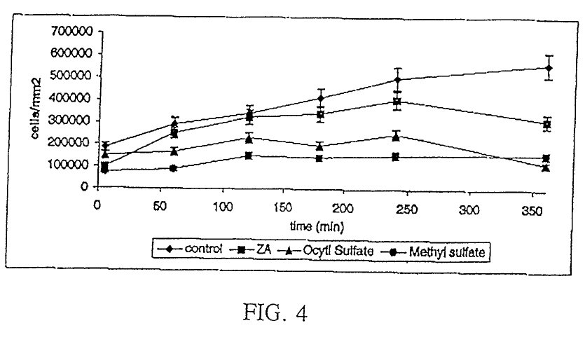

As shown in FIG. 4, the presence of dissolved zosteric acid, octyl sulfate, or methyl sulfate produced a significant reduction in the marine bacterium, Alteromonas atlantica adhesion relative the controls. The presence of methyl sulfate had the most dramatic effect upon adhesion, with adhesion remaining constant after 120 minutes at 150,000 cells/mm², while controls had greater than 700,000 cells/mm². Octyl sulfate also inhibited adhesion, demonstrating a slightly higher inhibitory activity than zosteric acid.

### Example 2

### Inhibition of Fungal Surface Attachment and Mycelial Development

To determine the effectiveness of sulfate esters at inhibiting fungal biofouling, the ability of zosteric acid to inhibit attachment of the fungus Aureobasidium pullulans to surfaces was examined.

### Materials and Methods

Aureobasidium pullulans (ATCC 34261) was grown on potato-dextrose agar and harvested according to ASTM G-21-90 protocols (American Society for Testing and Materials (1986) D1141-86, ASTM, Philadelphia, Pa.). The resulting spore suspension was used to inoculate liquid culture tubes containing 35 mL of growth medium (nutrient salts with 5 mM sucrose) and 15 mM zosteric acid. Zosteric acid-free medium was prepared as a control. A sterile microscope slide was added to each tube, the tubes were sealed and placed on a rotary shaker table at room temperature. One tube was harvested each day by removing the slide and counting the number of attached spores by direct microscopic counts, as described above.

### Results

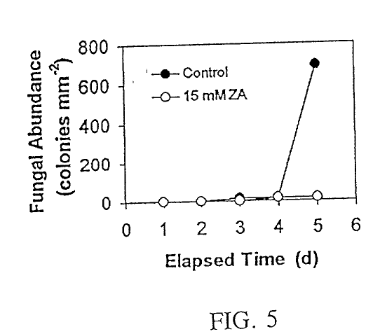

Fungal spores were observed to grow in both the presence and absence of zosteric acid, as indicated by the clouding of all tubes after Day 1. However, as shown in FIG. 5, the presence of zosteric acid prevented the attachment of the fungus to the glass slides. After 5 days incubation with A. pullalans, less than 20 germinated fungal colonies/mm² were observed on slides incubated in the additional presence of zosteric acid, compared to more than 600 germinated fungal colonies/mm² on control slides. Furthermore, fungal colonies in the media of zosteric acid free cultures were composed of multi-cellular (>20 cells) filaments, indicative of mycelial growth. In contrast, colonies in the zosteric acid treated cultures were generally small and round, exhibiting no evidence of filamentous growth or mycelial development.

### Example 3

### Sulfate Esters Bind Cell Surfaces of Biofouling Organisms

To investigate the mechanism behind the AF activity of sulfate esters, polyclonal antibodies specific for the sulfate ester zosteric acid were generated (BAbCo, Berkeley, Calif.). Preliminary testing of these antibodies for cross reactivity towards related compounds lacking the sulfate ester group (cinnamic acid, ferulic acid, coumaric acid) showed no cross reactivity, suggesting that the specific domain recognized by the antibodies probably includes the sulfate ester group. These antibodies were then used to investigate whether the sulfate ester AF agent zosteric acid directly binds fouling organisms.

The marine bacterium Shewanella putrefaciens were grown in cultures containing zosteric acid and were subsequently examined for bound zosteric acid using immuno-gold staining with the antibody described above. Electron microscopic examination of immunoprobed S. putrefaciens detected zosteric acid molecules bound to the surface of the bacteria. Furthermore, zosteric acid was observed to be present at high incidence at the sites of cell adhesion. In contrast to these agglutination sites, the majority of the cell surfaces as well as the continuous boundaries between daughter cells in dividing chains, showed no evidence of bound zosteric acid, as indicated by a lack of immuno-gold staining. These results indicate that sulfate esters bind to the surfaces of bacterial cells and suggest a possible relationship between sulfate ester binding sites and the sites of bacterial agglutination.

### Example 4

### Zosteric Acid Promotes Bacterial Agglutination

To further investigate the role of sulfate esters in agglutination, the ability of sulfate esters to facilitate the agglutination of bacterial cells was investigated. Log-phase cultures grown in the presence of zosteric acid were monitored spectrophotometrically (OD₆₀₀) for growth, and for agglutination in the presence of increasing amounts of zosteric acid.

### Materials and Methods

Cell Surface Binding Assays. The marine bacterium Shewanella putrefaciens was grown in marine broth in the presence of 16 mM zosteric acid. Dense log phase cells were harvest after 5 hours growth, and preserved in 0.5×Karnofsky's fixative (2% formaldehyde, 2.5% gluturaldehyde, 0.05 M sodium cacodylate, 0.25 M sucrose, pH 7.4) for 2 hours, and then transferred to a cacodylate buffer (0.05 M sodium cacodylate, pH 7.4) for storage. Cells were prepared for electron microscopic examination using immuno-gold staining techniques (Harlow, E. and Laine, D., Antibodies, A Laboratory Manual, Cold Spring Harbor Laboratory, 359-421; Roth et al., J. Histochem. Cytochem. 26: 1074-1081 (1978)). The primary antibody used in this study was an anti-zosteric acid polyclonal antibody (BAbCo, Richmond, Calif.).

Bacterial agglutination assays. Log-phase cultures of Shewanella putrefaciens were grown in complete seawater medium containing zosteric acid at a range of concentrations up to 20 mM. Cultures were counted for viable colony forming units at eight hours.

### Results

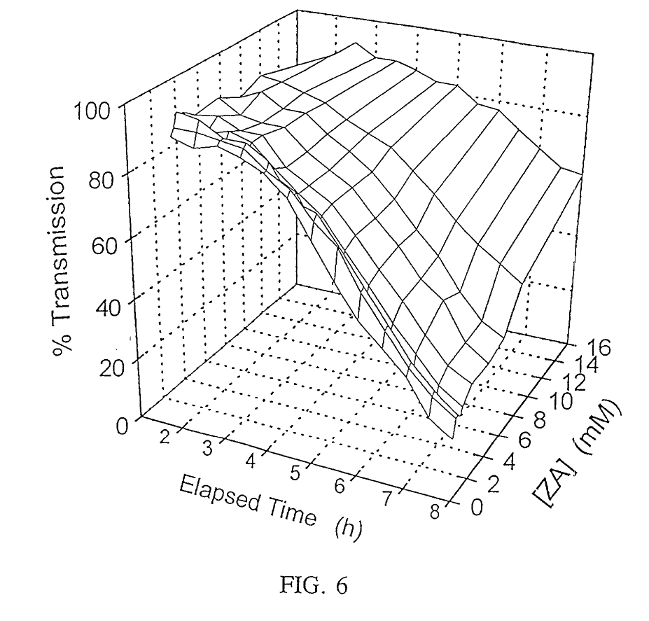

Although zosteric acid concentrations up to 16 mM did not inhibit the growth of S. putrefaciens in liquid culture, the presence of zosteric acid caused significant agglutination of S. putrefaciens in a concentration dependent manner. The agglutination observed was visible to the naked eye, and was more quantitatively detected as a decrease in optical density absorbance in cultures containing zosteric acid (FIG. 6). Counts of viable colony forming units at eight hours revealed no difference in cell density among the different cultures, thus the observed differences in absorption resulted from differences in bacterial agglutination, not differences in growth (cell division) rates among the cultures. Thus, zosteric acid promoted cell agglutination, but did not affect cell growth.

### Example 5

### Zosteric Acid Binds Heparin-Sensitive Sites

To investigate the ability of sulfate esters to mediate the interaction between biological surfaces involved in erythrocyte agglutination and blood clotting, erythrocyte agglutination assays and clot formation assays were performed using the sulfate ester zosteric acid.

### Materials and Methods

Red Blood Cell agglutination assays. Washed equine erythrocytes suspended in 1 mg/mL sodium citrate were placed in microtiter plates designed with wells containing hemispherical bottoms. Negative controls (no zosteric acid) were diluted in isotonic saline solution. Zosteric acid treated cells were diluted with saline containing zosteric acid at eight concentrations ranging from 0.005 to 5.0 mg/mL. Positive controls were exposed to the same range of high molecular weight heparin sulfate concentrations.

Clotting assays. Clotting time assays were performed using commercial kits (Sigma Chemical Co.) for prothrombin clotting time. Serum was harvested from 30 mL of whole human blood obtained by venous puncture using centrifugation to remove blood cells. Zosteric acid and high MW heparin were added to separate aliquots of the serum, producing concentrations from 0 to 5.0 mg/mL. Clotting times were determined for each concentration in duplicate according to the protocols provided with the kit.

### Results

In agglutination studies, equine erythrocytes were significantly agglutinated by zosteric acid at concentrations as low as 0.175 mg/mL. In contrast, the presence of high molecular weight heparin produced visible agglutination only at concentrations greater than 0.75 mg/mL. This result indicates that monomeric zosteric acid is eight times more reactive with cell surface glycoproteins and polysaccharides involved in cell agglutination, than high molecular weight heparin.

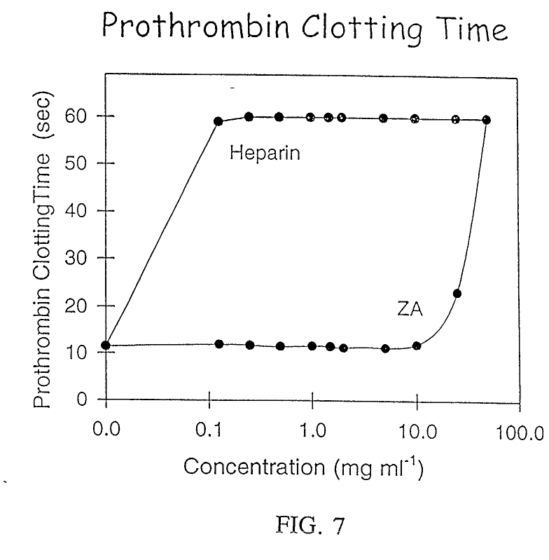

Zosteric acid was also effective at preventing clot formation, as measured by the prothrombin clotting time assays (FIG. 7), although this activity was considerably less than that observed for heparin. Heparin was effective at preventing clot formation at concentrations well below 0.1 mg/ml, while zosteric acid was effective only at concentrations exceeding 10 mg/ml. The effectiveness of heparin-like anticoagulants is strongly linked to size, with high molecular weight molecules being more effective. Thus, it is not surprising that the low molecular weight zosteric acid was considerably less effective than high molecular weight heparin in mediating clot formation. A derivative of zosteric acid or another sulfate ester that is higher in molecular weight may prove more effective. Nonetheless, these results indicate that zosteric acid interacts with cell surface glycoproteins and/or polysaccharides in a manner similar to that of heparin.

### Example 6

### Zosteric Acid Blocks Fertilization

The data above suggests that sulfate esters interact with sulfate ester-binding receptors in a variety of systems ranging from bacteria to mammalian erythrocytes. The fusion of sperm and egg cells in invertebrate and mammalian systems also appears to be mediated by organo-sulfate molecules such as the polysaccharides fucose sulfate and heparin. In light of this, the following experiments were initiated to identify potential AF properties of sulfate esters in fertilization.

A simple sea urchin assay was used to detect and quantitate the ability of sulfate esters to block sperm-egg fusion. Sea urchin sperm was added to freshly collected eggs in the presence and absence of increasing amounts of the sulfate ester zosteric acid, and the eggs were subsequently scored for successful fertilization.

### Materials and Methods

Fertilization assays. Healthy sea urchins were induced to spawn by injection with 0.5 M KCL solution. Freshly collected eggs were gently washed and resuspended in filtered sea water (FSW, pH 8.2) and aliquotted into separate tubes for fertilization assays. Zosteric acid was added to each tube from a concentrated stock dissolved in FSW (pH 8.2), along with additional FSW to ensure a constant volume in each tube. Equal amounts of sperm were added to each tube and percent fertilization was determined by direct microscopic counting. Eggs with elevated fertilization membranes were scored as fertilized. Assays were performed at sperm-limiting concentrations that allowed 95-99% fertilization in the absence of zosteric acid.

Sea urchin egg agglutination assays. Agglutination of unfertilized eggs by bindin was evaluated at the range of zosteric acid concentrations indicated in Table 1. Freshly spawned eggs were suspended in acidic seawater (pH 5) for 5 minutes to remove the outer jelly coat, and then washed 5 times in normal FSW (pH 8.2). Eggs were then transferred into plastic petri dished containing a range of zosteric acid concentrations and incubated for 15 minutes. Purified bindin (D. Epel, Stanford University) was added to the eggs at concentrations ranging from 1.2 to 12 μg/mL. The mixtures were gently agitated on a rotary shaker for 5 minutes and visually examined for agglutination. Bovine serum albumen (BSA) was used in separate assays to control for nonspecific agglutination of the dejellied eggs.

Dot blot assays. Serial dilutions of purified bindin, a covalently conjugated zosteric acid-BSA molecule, and an unconjugated mixture of free zosteric acid and BSA were pipetted onto a nitrocellulose membrane and allowed to air-dry. Standard immuno-blotting procedures were then employed to determine the reactivity between the blotted substrates and a polyclonal anti-zosteric acid antibody. The membrane was blocked in blotto (1% nonfat dry milk in phosphate buffered saline (PBS)) for 1 hour prior to probing. Probing was done in blotto for 1 hour. Primary antibody was anti-zosteric acid antibody, used at a 1:1000 dilution. Secondary antibody was alkaline phosphatase conjugated goat anti-rabbit (Southern Biotechnology Association, Inc.) and was used at a dilution of 1:1000. Rinses between probing were performed in triplicate in PBS-tween. The blot was developed in color reaction buffer (100 mM Tris, pH 9.5, 100 mM NaCl, 5 mM MgCl₂, 50 mg/mL Nitroblue Tetrazolium (Sigma), 50 ml/mL 5-bromo-4-chloro-3-indolyl phosphte (BCIP, Sigma)) for 20 minutes. Membranes were then transferred to stop buffer (10 mM Tris, pH 6.0, 5 mM EDTA) for 1 hour, and then transferred to freshwater, left overnight, and then dried.

### Results

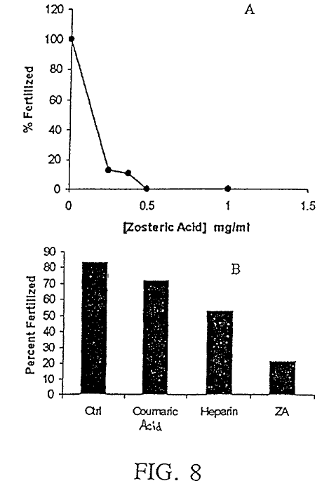

As shown in FIG. 8a, zosteric acid had a dose-dependent effect on sea urchin egg fertilization. Concentrations higher than 0.5 mg/mL (1.5 mM) completely blocked fertilization. Re-exposure of unfertilized eggs from the highest zosteric acid treatment, to fresh sperm, after washing in sea water, resulted in the fertilization of all eggs. This result demonstrates that the zosteric acid inhibition is reversible. The presence of zosteric acid had no detected effect on sperm viability or motility. Sperm exposed to zosteric acid were observed to swim actively through the jelly layer surrounding the egg without adhering to the egg surface or elevating the egg fertilization membrane, further supporting the conclusion that the antifouling effect of zosteric acid was mediated through inhibition of sperm-egg attachment.

The effectiveness of zosteric acid (1 mg/mL) at fertilization inhibition was compared to equal mass concentrations of coumaric acid (an unsulfated zosteric acid precursor) and high MW heparin. The presence of coumaric acid had no effect on egg fertilization, while the presence of heparin reduced fertilization by approximately 50%. Zosteric acid was at least twice as effective as heparin at inhibiting fertilization, reducing fertilization to 21% at this concentration (FIG. 8b).

The ability of zosteric acid to compete for the binding of sulfate receptor sites on the egg surface was investigated in egg agglutination assays. These experiments tested the ability of zosteric acid to interfere with the binding of the bindin molecule to unfertilized sea urchin eggs. Bindin added to unfertilized eggs causes them to agglutinate by cross linking sulfate receptors that are present on the surface of the eggs. Addition of zosteric acid inhibited this agglutination in a dose dependent manner (Table 1), suggesting a competitive interaction of bindin and zosteric acid for the sulfate receptor sites on the egg surface.

TABLE 1
The effect of zosteric acid on the agglutination
of sea urchin eggs by purified bindin.

| [ZA] mg mL⁻¹ | Agglutination |
|---|---|
| 3 | No |
| 1.5 | No |
| 0.75 | Yes |
| 0.30 | Yes |
| 0.15 | Yes |
| 0.075 | Yes |
| 0.03 | Yes |
| 0.015 | Yes |

Antibodies specific for zosteric acid (described above) exhibited strong cross reactivity with the bindin molecule in dot-blot assays, but not with other proteins, such as bovine serum albumin. This antibody cross reactivity indicates that zosteric acid and bindin share significant structural similarity at the site of antibody recognition, believed to be the sulfate moiety. Such structural similarities in the sulfate moieties between bindin and zosteric acid would explain why zosteric acid is an effective inhibitor of sea urchin fertilization.

### Example 7

### 4 t-Pentyl Phenyl Chlorosulfate (4-PPCS) Blocks Fertilization

The effect of 4-PPCS on inhibiting sea urchin fertilization was performed substantially as described for zosteric acid in Example 6. As can be seen in FIG. 7, 4-PPCS was essentially 100% effective in blocking sea urchin fertilization in the range of 1-10 mM, precisely the same range as zosteric acid was effective. As also can be seen in FIG. 7, when more sperm were added to the medium, the effect of the PPCS inhibition could be washed out be exceeding the binding capacity of the 4-PPCS in solution. In contrast to most biocidal agents, contact with 4-PPCS resulted in no adverse impacts on sperm motility.

### Example 8

### Antifouling Performance of KopCoat Rosin-based Coating Comprising Compounds of the Invention

KopCoat prepared a rosin-based coating formulation (ZA Form w/o PLAST; Code P-112LB) that contained about 12.5% (by weight) of each of five compounds of the invention as shown in Table 1. The compounds replaced all of the copper oxide in the formulations. It was found that the compounds served as plasticizers, yielding smooth and homogeneous coatings that dried quickly and yielded good quality coatings. The experimental coating with the different compounds was applied to glass coupons (no primer or surface preparation) for evaluation of AF active release rates under raw seawater conditions, and applied to fiberglass panels (4×5″) with an appropriate primer for total AF performance evaluations using ASTM methods under static emersion in Moss Landing Harbor, Moss Landing, Calif.

The following summarizes the release rates of the compounds from glass coupons and the performance of small panels subjected to static emersion in the field for 60 days.

Efficacy of Compounds

The antifouling efficacy of the compounds was evaluated using coupons coated with the PDMS silicone (GE RTV 11) matrix. The silicones were loaded with 15 and 30% (wt/wt) of each of the compounds. In all cases, the compounds demonstrated AF activity when coupons were exposed to running raw seawater (filtered to remove large particles and invertebrate larvae) from Monterey Bay. Release rates were determined using a spectrophotometric method, and it was found that AF function in the coating was obtained as long as active agent was being released. Release rates were between 25-200 g cm² d⁻¹ depending on the analog tested, and the 30% loadings yielded AF performance up to ca. 110 days. Based on these findings, the AF efficacy of the compounds was established setting the stage to examine their performance in a KopCoat coating matrix.

AF Performance of Compounds in a KopCoat Coating Matrix

The compounds were loaded at about 12.5% (wt/wt) into a lime rosin-based coating matrix by KopCoat. KopCoat reported that the analogs served as plastisizers and good quality and fast drying coating were obtained. Coatings were applied to glass slides (coupons) and fiberglass panels, with only the latter being coated with a primer coat. Coupons were deployed in the running seawater system described above and the panels were deployed in static emersion tests in Moss Landing Harbor. Using standard ASTM methods, panels were evaluated weekly as to physical properties of the coating integrity and fouling resistance. The 30- and 60-day ASTM ratings for the panels are provided below in Table 1.

TABLE 1
Foul resistance ratings (ASTM) of panels with a KopCoat rosin
coating containing different compounds (ca. 12.5% by weight)
compared with performance of a standard copper oxide coating
and the KopCoat coating without any AF compound. Panels were
subjected to static emersion in Moss Landing Harbor, Moss Land,
CA starting on 10 July 1999. Foul resistance ratings (ASTM)
are provided for 30- (10 Aug) and 60-day (10 Sep) performance
periods.

ASTM Foul Resistance Rating

| Compound | Acronym | 30-DAY | 60-DAY |
|---|---|---|---|
| 4-CPCS | KC1A | 100 | 53 |
| 4-OPCS | KC5A | 94 | 87 |
| 4-OPCS | KC5 | 93 | 82 |
| 4-CPCS | KC1 | 93 | 47 |
| 4-PPCS | KC4a | 90 | 47 |
| 4-PPCS | KC4 | 85 | 33 |
| 4-t-BPCS | KC3 | 84 | 48 |
| 4-sec-BPCS | KC2A | 84 | 29 |
| 4-sec-BPCS | KC2 | 78 | 14 |
| 4-t-BPCS | KC3A | 72 | 35 |
| Control | KC6A | 35 | 5 |
| Control | KC6 | 32 | 25 |
| Copper | CC | N/A | 100 |

Table 1 demonstrates the antifouling performance of all of the compounds in a commercial coating. A standard ASTM Foul Resistance Rating was determined. A rating of 100%=no fouling. All of the compounds performed well for 30 days and 3 gave greater than 45% (still good) after 60 days. None showed hard fouling through 60 days (excellent).

It can be concluded from these initial findings with no attempt to optimized properties of the coating matrix, formulation and analog loading properties that all of the compounds demonstrated AF efficacy in the KopCoat rosin-based coating matrix, and compared to control coatings containing no AF active compounds that nearly 100% fouling control was obtained with CPCS for 30 days while OPCS has maintained a fouling resistance rating >80 for 60 days. At 60 days the control are essentially 100% fouled and have extensive hard fouling (juvenal barnacles) while none of the coatings with compounds of the invention show any hard fouling including those with low (<30) ASTM fouling resistance ratings after the same time period. The bulk of the fouling on the compound-containing panels after 60 days is slime with some algal growth. The panels will remain in the water until they fail or reach ASTM foul resistance rating equal to the non-analog controls.

AF Performance on Coupon Coated with a KopCoat Coating Matrix

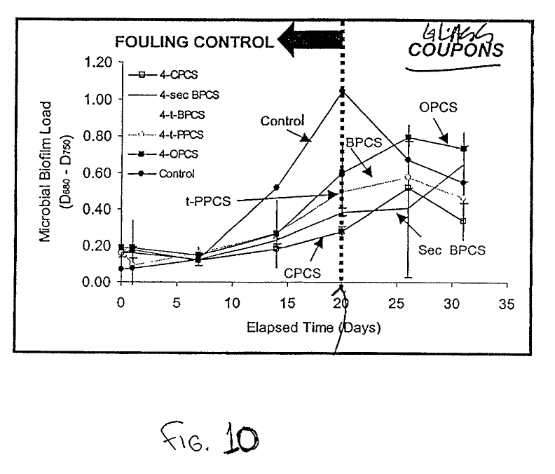

The glass-coated coupons did not perform as well as the panels in terms of coating physical integrity. Since coatings were applied on plain glass without silanization, inadequate binding to the glass surface resulted. Coatings cracked, peeled or blistered within about 20 days of exposure to running raw seawater, and as such, impaired AF performance. However, AF efficacy was determined as described for the silicones above and is summarized in FIG. 10. The CPCS showed the best AF performance, though in the first 20 days AF performance of all analogs was essentially the same. Loss of AF control starting at about 20 days corresponded to losses in coating physical integrity making evaluation of AF performance after 20 days unreliable.

Release Rates of Compounds from a KopCoat Coating Matrix on Coupons

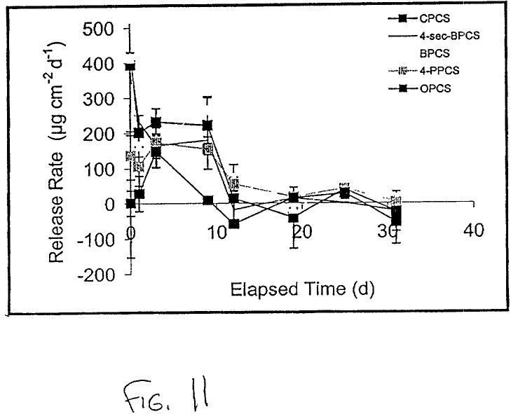

Release rates of analogs, determined spectrophotometricaly, from a KopCoat rosin-based coating matrix are summarized in FIG. 11. Important to note is:

1. Release rates from coupons cannot be directly extrapolated to release rates on panels without further evaluations;

2. Release rates are most likely overestimates because a non-ZA phenolic-like compound was also being released from the rosin matrix; and,

3. Release rates are influenced by coating integrity, and this varied among the coatings containing the different compounds.

Several conclusions can be drawn from the release rate data. First, all of the compounds show some but differing degrees on “controlled release” from the rosin matrix. Second, all of the compounds show AF efficacy at low release rates; and loss of coating physical integrity dramatically.

### Example 9

### Evaluation of Coated Coupons and Panels

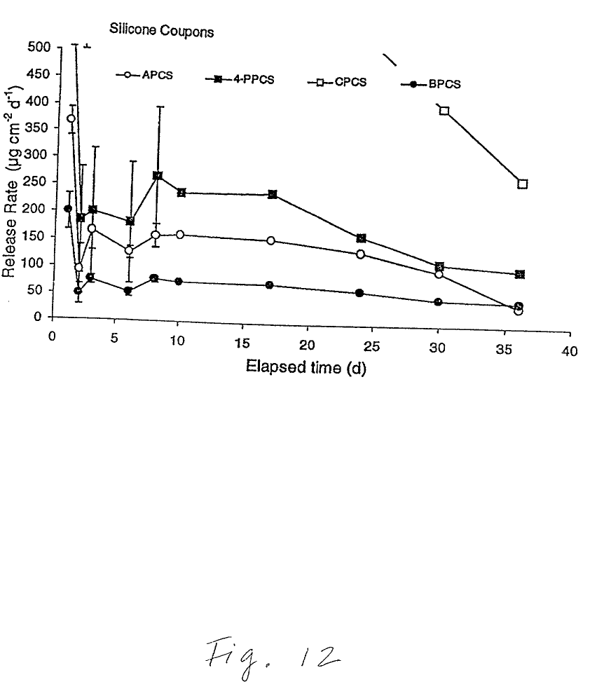

Release rates of chlorosulfates from RTV-11 silicone coupons were measured using direct UV absorbance spectroscopy. Quantitative evaluation of these peaks reveals an initial flash of the chlorosulfates at a high rate that settled down to a very slow decay rate for the next do d (FIG. 12). Release rates were considerably higher than the 10 μg cm⁻²d⁻¹ threshold required for long-term antifouling performance of the coating, but there appear to be significant differences among the four compounds evaluated. Release rates were highest for CPCS, followed by 4-PPCS, APCS. BPCS showed the lowest release rate. Previous experiments with RTV-11 silicone suggests that chlorosulfates should continue leaching at effective antifouling rates for at least 60 d, and we will continue monitoring them until the coatings become depleted.

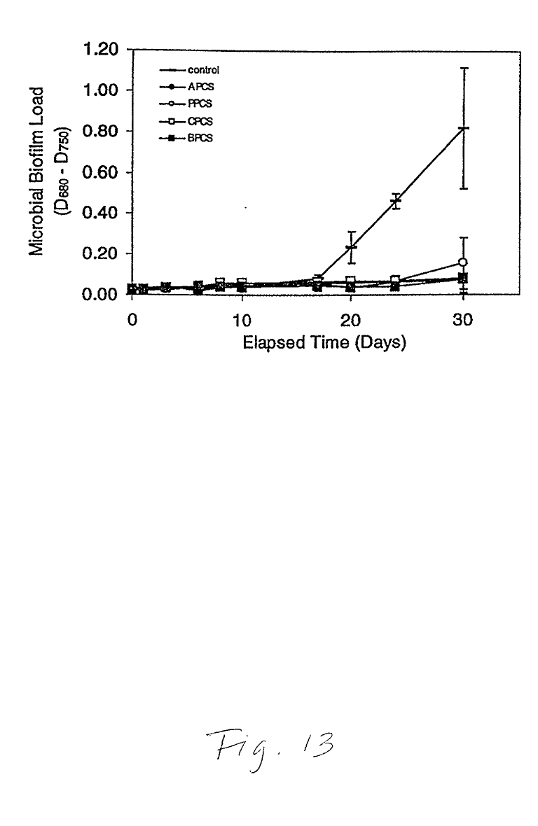

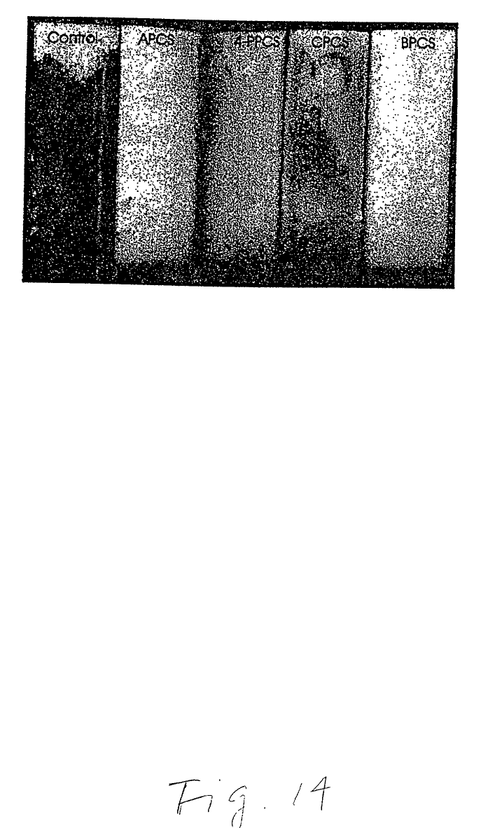

Antifouling properties of chlorosulfate compounds in RTV-11 coupons all show excellent control of algal biofilms after 30 days exposure in seawater. Coupons loaded with each of the four chlorosulfate agents were free of microbial biofilms at 30 days, as determined by spectroscopic examination (FIG. 13). Control coupons, however, were heavily fouled after 15 days exposure and supported a thick biofilm layer at 30 d dominated by microalgae (FIG. 14). Although unfouled, coupons containing 4-PPCS and APCS were visibly brown, probably a result of photooxidation of the phenolic compounds. There lack of detectable fouling, however, indicates that the oxidation did not significantly affect antifouling performance of the chlorosulfates. Coatings containing APCS and BPCS remained white and unoxidized. None of the silicone coupons showed any evidence of chipping, cracking or peeling from the glass slides at 30 d.

Release rates of 4-PPCS from Fluorochem Loop Polymer Coating were difficult to quantify for the first 5 d of seawater exposure due to leaching of materials with similar UV-absorption spectra from the controls. Subtracting the control spectra from the spectra produced by coupons loaded with 4-PPCS resulted in unreliably low estimates of release for the first 10 d. After 10 d exposure, however, leachates from the control coupons no longer presented an interference and quantification of release rates became reliable. At 21 days exposure, 4-PPCS release rates remained near 50 μg cm⁻²d⁻¹

### Equivalents

Those skilled in the art will recognize, or be able to ascertain using no more than routine experimentation, many equivalents of the specific embodiments of the invention described herein. Such equivalents are intended to be encompassed by the following claims.

1. A biofilm resistant surface comprising an effective amount of bioavailable anti-fouling compound represented by general structure 1: 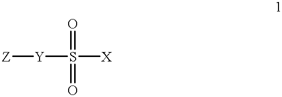
wherein
X represents —OH, —O(aryl), —O(acyl), —O(sulfonyl), —CN, F, Cl, or Br;
Y represents O, S, Se, or NR;
Z represents optionally substituted alkyl, heteroalkyl, cycloalkyl, heterocycloalkyl, aryl, heteroaryl, aralkyl, heteroaralkyl, or —(CH₂)ₘ—R₈₀;
R represents independently for each occurrence hydrogen, alkyl, heteroalkyl, aryl, heteroaryl, aralkyl, heteroaralkyl, or —(CH₂)ₘ—R₈₀;
R₈₀ represents independently for each occurrence aryl, cycloalkyl, cycloalkenyl, heterocyclyl, or polycyclyl; and
m is an integer in the range 0 to 8 inclusive, or a salt thereof,
wherein the compound or a biologically active fragment thereof is released from the surface.

2. A biofilm resistant surface of claim 1, wherein X represents —OH, F, Cl, or Br.

3. A biofilm resistant surface of claim 1, wherein Y represents O.

4. A biofilm resistant surface of claim 1, wherein Z represents optionally substituted alkyl, aryl, or —(CH₂)ₘ—R₈₀.

5. A biofilm resistant surface of claim 1, wherein Z represents optionally substituted alkylphenyl, heteroalkylphenyl, arylphenyl, or heteroarylphenyl.

6. A biofilm resistant surface of claim 1, wherein Z represents methyl, octyl, 4-(2-methylpropyl)phenyl, 4-(1,1-dimethylethyl)phenyl, 4-(1,1-dimethylpropyl)phenyl, 4-pentylphenyl, 4-(1-methyl-1-phenylethyl)phenyl, or 4-(1-methylheptyl)phenyl.

7. A biofilm resistant surface of claim 1, wherein R represents H or alkyl.

8. A biofilm resistant surface of claim 1, wherein X represents —OH, F, Cl, or Br; and Y represents O.

9. A biofilm resistant surface of claim 1, wherein X represents —OH or Cl; and Y represents O.

10. A biofilm resistant surface of claim 1, wherein X represents —OH, F, Cl, or Br; and Z represents optionally substituted alkyl, aryl, or —(CH₂)ₘ—R₈₀.

11. A biofilm resistant surface of claim 1, wherein X represents —OH or Cl; and Z represents optionally substituted alkyl, aryl, or —(CH₂)ₘ—R₈₀.

12. A biofilm resistant surface of claim 1, wherein X represents —OH, F, Cl, or Br; and Z represents optionally substituted alkylphenyl, heteroalkylphenyl, arylphenyl, or heteroarylphenyl.

13. A biofilm resistant surface of claim 1, wherein X represents —OH or Cl; and Z represents optionally substituted alkylphenyl, heteroalkylphenyl, arylphenyl, or heteroarylphenyl.

14. A biofilm resistant surface of claim 1, wherein X represents —OH, F, Cl, or Br; and Z represents methyl, octyl, 4-(2-methylpropyl)phenyl, 4-(1,1-dimethylethyl)phenyl, 4-( 1,1-dimethylpropyl)phenyl, 4-pentylphenyl, 4-(1-methyl-1-phenylethyl)phenyl, or 4-(1-methylheptyl)phenyl.

15. A biofilm resistant surface of claim 1, wherein X represents —OH or Cl; and Z represents methyl, octyl, 4-(2-methylpropyl)phenyl, 4-(1,1-dimethylethyl)phenyl, 4-(1,1-dimethylpropyl)phenyl, 4-pentylphenyl, 4-(1-methyl-1-phenylethyl)phenyl, or 4-(1-methylheptyl)phenyl.

16. A biofilm resistant surface of claim 1, wherein Y represents O; and Z represents optionally substituted alkyl, aryl, or —(CH₂)ₘ—R₈₀.

17. A biofilm resistant surface of claim 1, wherein Y represents O; and Z represents optionally substituted alkylphenyl, heteroalkylphenyl, arylphenyl, or heteroarylphenyl.

18. A biofilm resistant surface of claim 1, wherein Y represents O; and Z represents methyl, octyl, 4-(2-methylpropyl)phenyl, 4-(1,1-dimethylethyl)phenyl, 4-(1,1-dimethylpropyl)phenyl, 4-pentylphenyl, 4-(1-methyl-1-phenylethyl)phenyl, or 4-(1-methylheptyl)phenyl.

19. A biofilm resistant surface of claim 1, wherein X represents —OH, F, Cl, or Br; Y represents O; and Z represents optionally substituted alkyl, aryl, or —(CH₂)ₘ—R₈₀.

20. A biofilm resistant surface of claim 1, wherein X represents —OH or Cl; Y represents O; and Z represents optionally substituted alkyl, aryl, or —(CH₂)ₘ—R₈₀.

21. A biofilm resistant surface of claim 1, wherein X represents —OH, F, Cl, or Br; Y represents O; and Z represents optionally substituted alkylphenyl, heteroalkylphenyl, arylphenyl, or heteroarylphenyl.

22. A biofilm resistant surface of claim 1, wherein X represents —OH or Cl; Y represents O; and Z represents optionally substituted alkylphenyl, heteroalkylphenyl, arylphenyl, or heteroarylphenyl.

23. A biofilm resistant surface of claim 1, wherein X represents —OH, F, Cl, or Br; Y represents O; and Z represents methyl, octyl, 4-(2-methylpropyl)phenyl, 4-(1,1-dimethylethyl)phenyl, 4-(1,1-dimethylpropyl)phenyl, 4-pentylphenyl, 4-(1-methyl-1-phenylethyl)phenyl, or 4-(1-methylheptyl)phenyl.

24. A biofilm resistant surface of claim 1, wherein X represents —OH or Cl; Y represents O; and Z represents methyl, octyl, 4-(2-methylpropyl)phenyl, 4-(1,1-dimethylethyl)phenyl, 4-(1,1-dimethylpropyl)phenyl, 4-pentylphenyl, 4-(1-methyl-1-phenylethyl)phenyl, or 4-(1-methylheptyl)phenyl.

25. A biofilm resistant surface of claim 1, wherein the surface is a coating.

26. A biofilm resistant surface of claim 25, wherein the coating is temporary.

27. A biofilm resistant surface of claim 25, wherein the coating is semi-permanent.

28. A biofilm resistant surface of claim 25, wherein the coating is permanent.

29. A biofilm resistant surface of claim 1, wherein the effective amount reduces the binding of organisms to a defined area of a surface for a defined period of time by a factor of at least for relative to a control surface.

30. A biofilm resistant surface of claim 1, wherein the release rate of the compound from the surface is less than about 50 μgcm²d⁻¹.

31. A biofilm resistant surface of claim 1, wherein the release rate of the compound from the surface is less than about 10 μgcm²d⁻¹.

32. A biofilm resistant surface of claim 1, wherein the release of the compound is a sustained release.

33. A biofilm resistant surface of claim 1, wherein the the release of the compound is at a constant rate.

34. A coating comprising an effective amount of an anti-fouling compound represented by general structure 1: 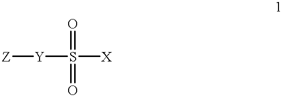
wherein
X represents —OH, —O(aryl), —O(acyl), —O(sulfonyl), —CN, F, Cl, or Br;
Y represents O, S, Se, or NR;
Z represents optionally substituted alkyl, heteroalkyl, cycloalkyl, heterocycloalkyl, aryl, heteroaryl, aralkyl, heteroaralkyl, or —(CH²)ₘ—R₈₀;
R represents independently for each occurrence hydrogen, alkyl, heteroalkyl, aryl, heteroaryl, aralkyl, heteroaralkyl, or —(CH₂)ₘ—R₈₀;
R₈₀ represents independently for each occurrence aryl, cycloalkyl, cycloalkenyl, heterocyclyl, or polycyclyl; and
m is an integer in the range 0 to 8 inclusive or a salt thereof,
wherein the coating releases the compound or a biologically active fragment thereof when in contact with a surface that is amenable to biofouling.

35. A coating of claim 34, wherein X represents —OH, F, Cl, or Br.

36. A coating of claim 34, wherein Y represents O.

37. A coating of claim 34, wherein Z represents optionally substituted alkyl, aryl, or —(CH₂)ₘ—R₈₀.

38. A coating of claim 34, wherein Z represents optionally substituted alkylphenyl, heteroalkylphenyl, arylphenyl, or heteroarylphenyl.

39. A coating of claim 34, wherein Z represents methyl, octyl, 4-(2-methylpropyl)phenyl, 4-(1,1-dimethylethyl)phenyl, 4-(1,1-dimethylpropyl)phenyl, 4-pentylphenyl, 4-(1-methyl-1-phenylethyl)phenyl, or 4-(1-methylheptyl)phenyl.

40. A coating of claim 34, wherein R represents H or alkyl.

41. A coating of claim 34, wherein X represents —OH, F, Cl, or Br; and Y represents O.

42. A coating of claim 34, wherein X represents —OH or Cl; and Y represents O.

43. A coating of claim 34, wherein X represents —OH, F, Cl, or Br; and Z represents optionally substituted alkyl, aryl, or —(CH₂)ₘ—R₈₀.

44. A coating of claim 34, wherein X represents —OH or Cl; and Z represents optionally substituted alkyl, aryl, or —(CH₂)ₘ—R₈₀.

45. A coating of claim 34, wherein X represents —OH, F, Cl, or Br; and Z represents optionally substituted alkylphenyl, heteroalkylphenyl, arylphenyl, or heteroarylphenyl.

46. A coating of claim 34, wherein X represents —OH or Cl; and Z represents optionally substituted alkylphenyl, heteroalkylphenyl, arylphenyl, or heteroarylphenyl.

47. A coating of claim 34, wherein X represents —OH, F, Cl, or Br; and Z represents methyl, octyl, 4-(2-methylpropyl)phenyl, 4-(1,1-dimethylethyl)phenyl, 4-(1,1-dimethylpropyl)phenyl, 4-pentylphenyl, 4-(1-methyl-1-phenylethyl)phenyl, or 4-(1-methylheptyl)phenyl.

48. A coating of claim 34, wherein X represents —OH or Cl; and Z represents methyl, octyl, 4-(2-methylpropyl)phenyl, 4-(1,1-dimethylethyl)phenyl, 4-(1,1-dimethylpropyl)phenyl, 4-pentylphenyl, 4-(1-methyl-1-phenylethyl)phenyl, or 4-(1-methylheptyl)phenyl.

49. A coating of claim 34, wherein Y represents O; and Z represents optionally substituted alkyl, aryl, or —(CH₂)ₘ—R₈₀.

50. A coating of claim 34, wherein Y represents O; and Z represents optionally substituted alkylphenyl, heteroalkylphenyl, arylphenyl, or heteroarylphenyl.

51. A coating of claim 34, wherein Y represents O; and Z represents methyl, octyl, 4-(2-methylpropyl)phenyl, 4-(1,1-dimethylethyl)phenyl, 4-(1,1-dimethylpropyl)phenyl, 4-pentylphenyl, 4-(1-methyl-1-phenylethyl)phenyl, or 4-(1-methylheptyl)phenyl.

52. A coating of claim 34, wherein X represents —OH, F, Cl, or Br; Y represents O; and Z represents optionally substituted alkyl, aryl, or —(CH₂)ₘ—R₈₀.

53. A coating of claim 34, wherein X represents —OH or Cl; Y represents O; and Z represents optionally substituted alkyl, aryl, or —(CH₂)ₘ—R₈₀.

54. A coating of claim 34, wherein X represents —OH, F, Cl, or Br; Y represents O; and Z represents optionally substituted alkylphenyl, heteroalkylphenyl, arylphenyl, or heteroarylphenyl.

55. A coating of claim 34, wherein X represents —OH or Cl; Y represents O; and Z represents optionally substituted alkylphenyl, heteroalkylphenyl, arylphenyl, or heteroarylphenyl.

56. A coating of claim 34, wherein X represents —OH, F, Cl, or Br; Y represents O; and Z represents methyl, octyl, 4-(2-methylpropyl)phenyl, 4-(1,1-dimethylethyl)phenyl, 4-(1,1-dimethylpropyl)phenyl, 4-pentylphenyl, 4-(1-methyl-1-phenylethyl)phenyl, or 4-(1-methylheptyl)phenyl.

57. A coating of claim 34, wherein X represents —OH or Cl; Y represents O; and Z represents methyl, octyl, 4-(2-methylpropyl)phenyl, 4-(1,1-dimethylethyl)phenyl, 4-(1,1-dimethylpropyl)phenyl, 4-pentylphenyl, 4-(1-methyl-1-phenylethyl)phenyl, or 4-(1-methylheptyl)phenyl.

58. A coating of claim 57, wherein the coating is temporary.

59. A coating of claim 57, wherein the coating is semi-permanent.

60. A coating of claim 57, wherein the coating is permanent.

61. A coating of claim 34, wherein the effective amount reduces the binding of organisms to a defined area of a surface for a defined period of time by a factor of at least for relative to a control surface.

62. A coating of claim 34, wherein the release rate of the compound from the surface is less than about 50 μgcm²d⁻¹.

63. A coating of claim 34, wherein the release rate of the compound from the surface is less than about 10 μgcm²d⁻¹.

64. A coating of claim 34, wherein the release of the compound is a sustained release

65. A coating of claim 34, wherein the the release of the compound is at a constant rate

66. A coating of claim 34, which is a liquid.

67. A coating of claim 34, which is a gas or vapor.

68. A coating of claim 34, which is a paste or other semi-solid state.

69. A coating of claim 34, which is a solid.

70. A coating of claim 34, which is a liquid and solidifies into a hard coating on a surface.

71. A coating of claim 34, which is a polish.

72. A coating of claim 34, which is a surface cleaner.

73. A coating of claim 34, which is a caulk

74. A coating of claim 34, which is an adhesive.

75. A coating of claim 34, which is a finish.

76. A coating of claim 34, which is a wax

77. A coating of claim 34, which is a polymerizable composition.
